(19) United States
(12) Patent Application Publication
(10) Pub. No.: US 2018/0373847 A1
(43) Pub. Date: Dec. 27, 2018

(54) Broadcast DRM License Support for Receive Only Devices

(71) Applicant: QUALCOMM Incorporated, San Diego, CA (US)

(72) Inventors: Charles Nung LO, San Diego, CA (US); Giridhar Dhati MANDYAM, San Diego, CA (US); Gordon Kent WALKER, Poway, CA (US); Thomas STOCKHAMMER, Bergen (DE)

(21) Appl. No.: 16/016,566

(22) Filed: Jun. 23, 2018

Related U.S. Application Data
(60) Provisional application No. 62/525,149, filed on Jun. 26, 2017.
(60) Provisional application No. 62/525,585, filed on Jun. 27, 2017.
(60) Provisional application No. 62/536,313, filed on Jul. 24, 2017.

(51) Int. Cl. G06F 21/10; H04L 29/06; H04L 9/32; H04W 12/06; H04W 12/04

(52) U.S. Cl. CPC G06F 21/10; H04L 63/0428; H04L 9/3226; H04L 2209/80; H04W 12/04; H04L 2209/601; H04L 2209/603; H04W 12/06

(57) ABSTRACT

Various aspects include methods for facilitating digital rights management (DRM) within an electronic device. Various aspect methods may include receiving a first broadcast message, storing a DRM license object extracted from the DRM license-related message, receiving a DRM license request message generated by a content decryption module (CDM) of the electronic device, determining that the DRM license object is associated with the encrypted content received by the electronic device during the broadcast content session based on the identification information included in the DRM license request message received from the CDM of the electronic device, and sending the DRM license object to the CDM of the electronic device. The first broadcast message may be a DRM license-related message generated by a broadcast server. The DRM license request message may include identifier information associated with encrypted content received by the electronic device during a broadcast content session.

### RELATED APPLICATIONS

This application claims the benefit of priority to U.S. Provisional Application No. 62/525,149 filed on title Jun. 26, 2017, entitled “Broadcast DRM License Support for Receive Only Devices”, U.S. Provisional Application No. 62/525,585 filed on Jun. 27, 2017, entitled “Broadcast DRM License Support for Receive Only Devices”, and U.S. Provisional Application No. 62/536,313 filed on Jul. 24, 2017, entitled “Broadcast DRM License Support for Receive Only Devices” the entire contents of all of which are herein incorporated by reference for all purposes.

### BACKGROUND

Television content and service providers may require the use of digital rights management (DRM) to protect premium content such as pay-per-view movies, concerts, and sporting events. Typically, in over the top (OTT) TV services delivery and subscription-based systems such as Internet protocol television (IPTV), electronic devices acquire a license or rights object which defines use permissions and constraints for consumption of the delivered content along with an associated security key to enable decryption of the protected content.

DRM protection of TV content will continue to be importation as next-generation digital broadcast TV systems are implemented. It is desirable to leverage standards-based technologies such as Moving Picture Experts Group (MPEG) common encryption (MPEG-CENC) and world wide web consortium (W3C) encrypted media extensions (EME) for interoperable use of DRM technologies such as Microsoft™ PlayReady™ and Google™ Widevine™ across heterogeneous device platforms by different service providers. The receiving devices that are broadband-enabled (e.g., configured to transmit and receive) may acquire licenses or rights objects and keys directly from the license provider or rights issuer using unicast communications. However, traditional DRM license or rights object acquisition methods are unable to be implemented by devices that are not broadband-enabled (e.g., only capable of broadcast reception), which may be referred to as “receive only electronic devices.”

### SUMMARY

Various aspects include methods for facilitating DRM within an electronic device that may include receiving, by a processor of an electronic device via a wireless communication receiver of the electronic device, a first broadcast message. The first broadcast message may be a digital rights management (DRM) license-related message generated by a broadcast server. Various aspects may further include storing, by the processor, a DRM license object extracted from the DRM license-related message in a cache of the electronic device, and receiving, by the processor, a DRM license request message generated by a content decryption module (CDM) of the electronic device. The DRM license request message may include identifier information associated with encrypted content received by the electronic device during a broadcast content session. Various aspects may further include determining, by the processor, that the DRM license object stored in the cache of the electronic device is associated with the encrypted content received by the electronic device during the broadcast content session based on the identification information included in the DRM license request message received from the CDM of the electronic device, and sending, by the processor, the DRM license object stored in the cache of the electronic device to the CDM of the electronic device in response to determining that the DRM license object stored in the cache of the electronic device is associated with the encrypted content received by the electronic device during the broadcast content session.

In some aspects, determining that the DRM license object stored in the cache of the electronic device is associated with the encrypted content received by the electronic device during the broadcast content session based on the identification information included in the DRM license request message received from the CDM of the electronic device may include extracting the identification information from the DRM license request message received from the CDM of the electronic device, comparing the identification information extracted from the DRM license request message with information associated with one or more DRM license objects stored in the cache to determine whether a DRM license object stored in the cache is associated with the encrypted content received by the electronic device during the broadcast content session, identifying the DRM license object from the one or more DRM license objects stored in the cache of the electronic device in response to determining that the identification information extracted from the DRM license request message relates to the information associated with the DRM license object, and instructing the cache to send the DRM license object to the CDM of the electronic device.

Some aspects may further include sending an error message to the CDM executing on the electronic device in response to determining that no DRM license object is stored in the cache of the electronic device is associated with the encrypted content received by the electronic device during the broadcast content session.

Some aspects may further include determining whether the first broadcast message includes an identifier associated with the electronic device. In some aspects, storing the DRM license object extracted from the DRM license-related message in the cache of the electronic device may include storing the DRM license object extracted from the DRM license-related message in the cache of the electronic device in response to determining that the first broadcast message includes the identifier associated with the electronic device.

In some aspects, the identifier information of the DRM license request message may include a license server identifier corresponding to a DRM license associated with the encrypted content included in the broadcast content session.

In some aspects, the DRM license request message may include a uniform resource identifier (URI).

Some aspects may further include receiving, via the wireless communication receiver, a second broadcast message, storing the LTK object included in the second broadcast message to the cache of the electronic device in response to determining that the second broadcast message includes an identifier of a DRM system by which the broadcast service subscription is protected, and sending the LTK object stored in the cache of the electronic device to the CDM executing on the electronic device. The second broadcast message may be a DRM license-related message including a long term key (LTK) object associated with a broadcast service subscription that the electronic device is authorized to receive. The second broadcast message may be generated by the broadcast server. The LTK object may be associated with the identifier of the DRM system included in the second broadcast message.

Some aspects may further include receiving, via the wireless communication receiver, a third broadcast message different from the first broadcast message or the second broadcast message, and different from the encrypted content received during the broadcast content session. The first broadcast message or the second broadcast message may be transmitted from the broadcast server according to a predetermined schedule. The third broadcast message may include service level signaling. The service level signaling of the third broadcast message may include a distribution window description (DWD) fragment. The DWD fragment may include information associated with the predetermined schedule in which the first broadcast message or the second broadcast message is transmitted from the broadcast server.

In some aspects, the electronic device may only be capable of operating in a receive-only mode.

In some aspects, the electronic device may be configured to operate in a receive-only mode and a transmit mode.

In some aspects, receiving the first broadcast message or the second broadcast message may include receiving the first broadcast message or the second broadcast message when the electronic device is operating in the receive-only mode.

Some aspects may further include receiving, via the wireless communication receiver of the electronic device, the encrypted content during the broadcast content session when the electronic device is operating in the receive-only mode.

Some aspects may further include executing middleware configured to communicate with the CDM, and executing an application configured to facilitate communicating DRM information between the middleware and the CDM.

In some aspects, the application may communicate information between the middleware and the CDM using a WebSocket protocol.

Further aspects include an electronic device having a wireless communication receiver and a processor configured with processor executable instructions to perform operations of any of the methods summarized above. Further aspects include an electronic device having means for performing functions of any of the methods summarized above. Further aspects include a non-transitory processor-readable storage medium having stored thereon processor-executable instructions configured to cause a processor of an electronic device to perform operations of any of the methods summarized above.

Various embodiments include methods for broadcasting DRM information that may be performed by a processor of a broadcast server that may include receiving a first DRM license object message including a first DRM license object and a second DRM license object message including a second DRM license object generated by a license server. The first DRM license object and the second DRM license object may be associated with one or more wireless electronic devices capable of operating in a receive-only mode. The methods may further include determining one or more identifiers based on the first DRM license object message and the second DRM license object message received from the license server, the one or more identifiers including at least one of a DRM system device identifier, a DRM system device group identifier, or a key identifier, generating a first DRM license-related message including the first DRM license object and at least one of the determined identifiers and a second DRM license-related message including the second DRM license object and at least one of the determined identifiers, and broadcasting the first DRM license-related message and the second DRM license-related message.

Further aspects include a broadcast server having a processor configured with processor executable instructions to perform operations of the methods summarized above. Further aspects include a broadcast server having means for performing functions of any of the methods summarized above. Further aspects include a non-transitory processor-readable storage medium having stored thereon processor-executable instructions configured to cause a processor of a broadcast server to perform operations of any of the methods summarized above.

### BRIEF DESCRIPTION OF THE DRAWINGS

The accompanying drawings, which are incorporated herein and constitute part of this specification, illustrate example embodiments, and together with the general description given above and the detailed description given below, serve to explain the features of various embodiments.

FIG. 1 is a communication system block diagram of a network suitable for use with the various embodiments.

FIG. 2 illustrates an example functional architecture system including a receive only electronic device.

FIG. 3 illustrates an embodiment method for rendering encrypted content received by a receive-only electronic device.

FIG. 4 illustrates a signal flow diagram for a method of rendering encrypted content received by a receive-only electronic device.

FIG. 5 is a component diagram of an example personal device suitable for use with various embodiments.

FIG. 6 is a component diagram of an example receive-only electronic device suitable for use with various embodiments.

FIG. 7 is a component diagram of an example server device suitable for use with various embodiments.

FIG. 8 illustrates a signal flow diagram for a method of rendering encrypted content received by an electronic device operating in a receive-only mode.

FIG. 9 illustrates a signal flow diagram for a method of rendering encrypted content received by an electronic device operating in a unicast mode.

FIG. 10 illustrates a signal flow diagram for a method of obtaining a broadcast DRM license by an electronic device operating in a receive-only mode.

FIG. 11 is a signal flow diagram illustrating message exchanges in a method of registering an electronic device operating in a receive-only mode to receive a broadcast subscription.

FIG. 12 illustrates an embodiment method for facilitating DRM in an electronic device.

FIG. 13 illustrates an embodiment method for determining whether a DRM license object corresponds to encrypted content.

FIG. 14 illustrates an embodiment method for facilitating DRM in an electronic device using an application.

FIG. 15 illustrates an embodiment method for tuning a wireless receiver to receive broadcast messages.

FIG. 16 illustrates an embodiment method for filtering DRM license-related messages.

FIG. 17 illustrates another embodiment method for facilitating DRM in an electronic device.

FIG. 18 illustrates an embodiment method for broadcasting DRM information.

### DETAILED DESCRIPTION

Various embodiments will be described in detail with reference to the accompanying drawings. Wherever possible, the same reference numbers will be used throughout the drawings to refer to the same or like parts. References made to particular examples and embodiments are for illustrative purposes, and are not intended to limit the scope of the claims.

Various embodiments include methods that may be implemented on a processor of an electronic device for rendering encrypted content. Various embodiments may include an electronic device configured to receive broadcast TV reception, TV services over evolved Multimedia Broadcast Multicast Services (eMBMS), etc., as well as any other content transmitted using a wireless communication protocol including digital television. In some embodiments, the electronic device may be a broadcast reception electronic device only capable of receiving signals. In some embodiments, the receive-only electronic device may be an electronic device including a built-in eMBMS/enTV receive module that operates in receive-only mode and lacks unicast communication capabilities. In some embodiments, the electronic device may be an electronic device configured to operate in a receive-only mode, a transmit mode, or a simultaneous transmit and receive mode. The electronic device may transmit and/or receive information using various broadcast and/or unicast methods. In some embodiments, the methods for rendering encrypted content at a receive-only electronic device may include a solution for DRM license acquisition by receive-only devices that may be implemented using existing, related standards such as MPEG CENC, W3C EME, Advanced Television Systems Committee (ATSC) standards 3.0, and Dynamic Adaptive Streaming over HTTP (MPEG-DASH).

Various embodiments overcome shortcomings of conventional DRM license acquisition methods for receive-only electronic devices.

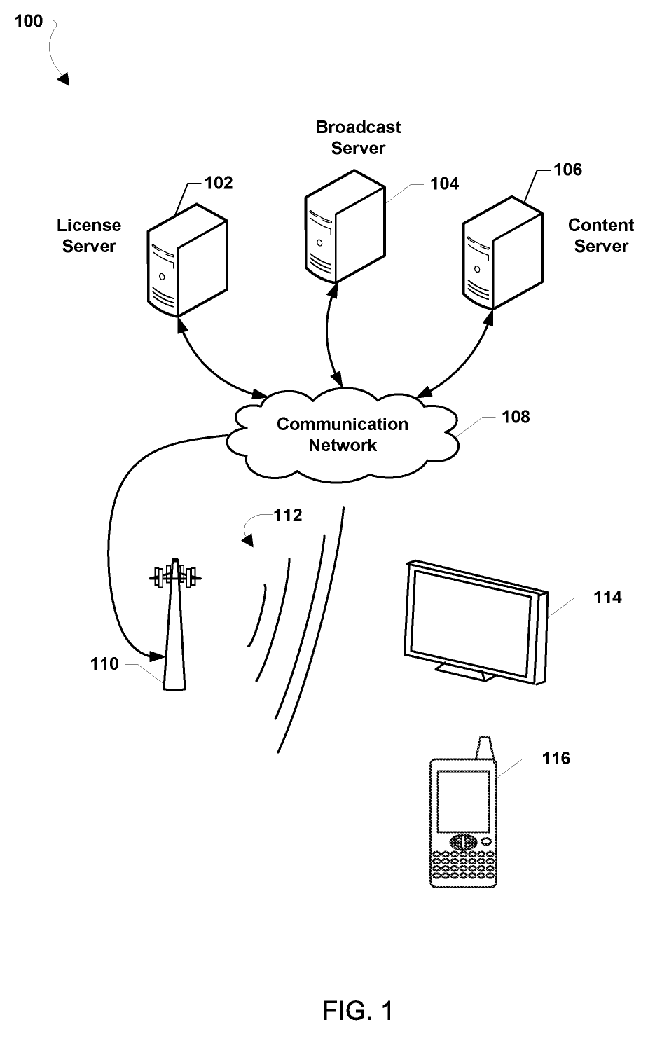

FIG. 1 illustrates a network 100 suitable for use with the various embodiments. The network 100 may include a DRM license server 102, a broadcast server 104, a content server 106, a broadcast antenna 110, and one or more receive-only electronic devices such as a television 114 or a personal electronic device 116. The DRM license server 102, the broadcast server 104, and/or the content server 106 may communicate via a communication network 108. The communication network 108 may be any type of network such as a wired network, a wireless network, a private network, a public network, or any combination thereof. Moreover, communication channels associated with the communication network 108 may be any type of wired communication channel, wireless communication channel, or a combination thereof. While only a television 114 and a personal electronic device 116 are illustrated in FIG. 1, the network 100 may include any number of electronic devices capable of operating in a receive-only mode.

The license server 102 may be an entity configured to manage and coordinate the generation and/or issuance of a license corresponding to encrypted content subject to protection. For example, the encrypted content may be subject to copyright protection where a user may use or purchase a license to access the encrypted content for an agreed upon purchase or subscription fee. In some embodiments, the license server 102 may be a Google™ Widevine™ or Microsoft™ PlayReady™ DRM server.

In some embodiments, the license server 102 may generate a DRM license that states the permissions and constraints associated with the consumption of the protected content. The generated DRM license may be completely encrypted or only portions of the DRM license may be encrypted. For example, rather than the entire the DRM license being encrypted, some information in the DRM license may be unencrypted, such as to enable the information to be used to authenticate the license, while the rest of the information is protected by encryption within encryption fields. Including authenticatable information within the DRM license allows for information such as dates, a unit address, or a public key hash to be readable by a receiving device without first decrypting the encrypted portions of the DRM license. In some examples, identifiers such as group identifiers, device identifiers, and/or license server identifiers may be included in the authenticatable information, and the content decryption key may be included in an encrypted field of the DRM license.

The license server 102 may have access to digital certificates that provide public keys where each public key may be applicable to one or more devices. When the license server 102 generates a message to be broadcasted to one or more devices, the license server 102 may provide a hash of the public key associated with the message to the broadcast server 104. This hash (e.g., SHA-256) may ensure that the key identifier is of a manageable size yet can still be considered unique to the public key (e.g., associated with the digital certificate).

The hash of the public key may be used as an identifier by a receiving device. For example, a broadcast receiver (e.g., the receive-only devices 114 and 116), knowing its own certificate, may verify incoming license messages based on the hash where the broadcast receiver downloads only those messages intended for the broadcast receiver based on the hash. Since the hash is significantly smaller (e.g., includes fewer bytes) than the public key, using a hash rather than the public key for identification purposes may increase performance and decrease the time needed to identify whether the broadcast DRM license associated with the hash is destined for the receiving device performing the identification. In addition, the hash may be precomputed such that if the hash is not encrypted and already precomputed, the receiving device may more easily sort the licenses and determine whether the DRM license should be downloaded to the receive-only receiving device.

The broadcast server 104 may be configured to broadcast messages 112 to the receive-only electronic devices. In some embodiments, the broadcast server 104 may broadcast DRM licenses generated by the license server 102 and encrypted content from the content server 106. The broadcast server 104 may broadcast different DRM licenses to different receiving devices and/or the broadcast server 104 may broadcast the same DRM license to a plurality of different receiving devices.

In some embodiments, the broadcast server 104 may be a headend such as a headend associated with a television broadcaster entity. Alternatively or additionally, the broadcast server 104 may be Broadcast Multicast Service Center (BMSC) of a mobile operator.

In some embodiments, when the broadcast server 104 receives a DRM license, the broadcast server 104 may simply re-transmit the DRM licenses received from the license server 102 to the receive-only devices 114 and 116. Alternatively, the broadcast server 104 may generate a message to be broadcast to the receive-only devices 114 and 116 that includes the DRM license, yet has a format different from the message received from the license server 102. For example, the broadcast server 104 may add information that will allow the receiving device to determine whether or not the DRM license included in the message is intended for the receiving device. In some embodiments, the broadcast server 104 may format the message such that the receiving device may determine whether or not the DRM license included in the message is intended for the receiving device before the receiving device downloads the message to the receiving device.

In some embodiments, the broadcast server 104 may generate an identifier associated with the license server 102, one or more identifiers associated with the device intended to receive the broadcast message (e.g., receive-only devices 114 or 116), and/or one or more identifiers associated with the encrypted content received from the content server 106. In various embodiments, the one or more identifiers associated with the receive-only devices intended to receive the broadcast message may include identifiers associated with: a type of classification corresponding to the target receiving device including a manufacturer identifier; an identifier corresponding to a group including the device (e.g., wall-mounted, smart TV, receive-only device, device configured to operate in a receive-only mode and a unicast mode, etc.); and/or a unique identifier specific to an individual receiving device such as a media access control (MAC) address or other device specific identifier.

In some embodiments, the broadcast server 104 may generate an identifier associated with a type of media that is included in the encrypted content received from the content server 106. For example, the media to be delivered may include real time streaming media objects and/or non-real time media objects.

After generating the one or more identifiers associated with the license server 102, the receiving devices (e.g., receive-only devices 114 and/or 116), and the encrypted content, the broadcast server 104 may generate a broadcast message that includes the one or more identifiers and the DRM license. In some embodiments, the identifiers included in the broadcast message may be formatted using a Uniform Resource Identifier (URI) scheme and the one or more identifiers may be URIs such as a Uniform Resource Name (URN) and/or a universally unique identifier (UUID).

When the broadcast message includes a UUID, the UUID may be formatted identically to the value of the @schemeIdUri used for Dynamic Adaptive Streaming over HTTP (DASH) Media Presentation Description (MPD) content protection descriptor. Specifically, the UUID may include the “urn:uuid:” prefix.

In some embodiments, the receiving device (e.g., receive-only device 114 or 116) may use the identifier information included in the URI received from the broadcast server 104 to determine whether or not to download and cache the DRM license included in the broadcast message. In addition, the receiving device may select the one or more DRM licenses using the identifier information included in the URI based on the request from the CDM for a DRM license corresponding to the encrypted content where the CDM generates the request for the DRM license by extracting license server identifier information from the encrypted content.

The URIs included in the broadcast DRM license message may be constructed in a manner that clearly identifies which DRM system (e.g., license server that issued the DRM license), which device group, and which type of produce (e.g., Sony™ TVs) for which a given URI/DRM license applies. For example, when the broadcast message including the DRM license targets one or more devices, the receiver devices may download the DRM license based on the identifiers included in the broadcast emission communicated using the URI. The stored DRM licenses may be retrieved from a memory of the receiving device and delivered to the CDM from the device cache based on the identifiers associated with the information included in the URI instead of contacting a network side license server. Since the stored DRM licenses are delivered via http(s) from the device cache, the CDM may not be configured to differentiate whether the requested DRM license has been delivered from a network side license server (e.g., broadband license delivery) or a local cache (broadcast license delivery).

In some embodiments, business service agreements may be established between the DRM license server 102 and the broadcast server 104. For example, the business service agreements may be used to facilitate protecting content distributed by the broadcasting server 104 using licenses generated by the DRM license server 102.

The receive-only devices 114 and 116 may be any device configured to only receive MBMS UE such as a TV set that has a MBMS receiver chip or modem, an ATSC 3.0 receiver, etc. For example, the receive-only devices 114 and/or 116 may include an MBMS modem but not have upstream capabilities (e.g., without the ability to transmit data via the communication network 108). Alternatively, the receive-only device 114 or 116 may be a device configured to operate in both a receive-only mode and a unicast mode. For example, the receive-only device 114 or 116 may operate in a receive-only mode for various reasons. For instance, the receive-only device 114 or 116 may enable the receive-only mode to conserve battery power, to limit data usage on provider plans, when a secure network connection is currently unavailable (e.g., during travel, etc.), etc. In some embodiments, before the receive-only device 114 or 116 enters the receive-only mode, the receive-only device 114 or 116 may generate a notification informing the license server 102, the broadcast server 104, and/or the content server 106 that the receive-only device 114 or 116 is entering the receive-only mode such that the license server 102, the broadcast server 104, and/or the content server 106 may modify the messages broadcast to the receive-only device 114 or 116 to take into account that the receive-only device 114 or 116 is operating in the receive-only mode and is unable to respond to received messages.

When the receive-only devices 114 and 116 are configured to operate in both a receive-only mode and a unicast mode, a key change procedure may be implemented to update or change the digital license and private key stored at the receive-only devices 114 and 116. For example, if the unicast mode is enabled by the receive-only device 114 or 116 and the receive-only device 114 or 116 establishes a secure network connection, the receive-only device 114 or 116 may contact the license server 102 to update the digital certificate and key pair. After the digital certificate and key pair are updated, the receive-only device 114 or 116 may store the updated digital certificate and associated private key in memory. The license server 102 may then use the updated public key associated with the updated digital certificate for the DRM licenses generated after the key change procedure has occurred.

In some embodiments, the personal electronic device 116 may include any one or all of cellular telephones, smart phones, personal or mobile multimedia players, personal data assistants (PDAs), laptop computers, personal computers, tablet computers, smart books, palm-top computers, electronic mail receivers, multimedia Internet enabled cellular telephones, gaming controllers, tuners, television antennas, streaming media players (such as, ROKU™ or CHROMECAST™ or FIRE TV™), smart televisions, digital video recorders (DVRs), and similar personal electronic devices which include a programmable processor and memory and circuitry for receiving Over-the-Air (OTA) broadcasts of content.

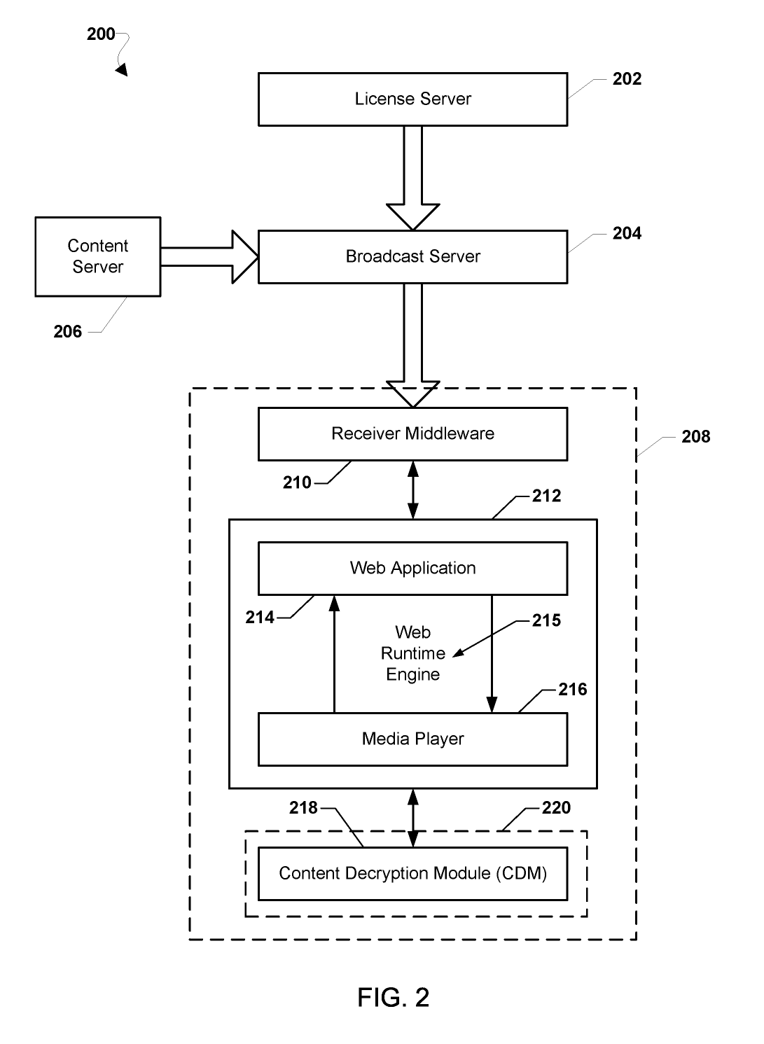

FIG. 2 illustrates an example functional architecture system 200 configured to distribute DRM licenses from the license server 202 to the receive-only device 208 and encrypted content from the content server 206 via the broadcast server 204. As illustrated in FIG. 2, the receive-only electronic device 208 architecture may include a receiver middleware element 210, a web runtime engine 212 including a web application element 214 and a media player 216, and a trusted execution environment 220 including a content decryption module (CDM) 218.

In various embodiments, a digital certificate and a private key associated with the digital certificate may be stored in memory of the receive-only electronic device 208 for use in conjunction with a selected broadcast DRM message in order to obtain a DRM license and a content decryption key attached to that license where the content decryption key is used to decrypt the encrypted content. In some embodiments, the digital certificate is an electronic document used to prove ownership of the associated public key by the receiving device. The digital certificate may include information about the public key, information about the identity of the owner (or subject) of digital certificate, and a digital signature of a Certificate Authority (CA) that has verified the contents of the digital certificate (e.g., issuer of digital certificate). The license server 202 may be assured that the DRM license that is issued by the license server 202 to a receiving device (or a class of devices), when encrypted by the device's (or device class's) public key, can only be decrypted by that device (or device class).

In some embodiments, the digital certificate and associated private key may be stored in the receive-only electronic device 208 during manufacturing. Alternatively or additionally, the digital certificate and associated private key may be stored in a portable memory device plugged into the receive-only electronic device 208. In some embodiments, the digital certificate and the associated private key may be stored in secure memory of the receive-only electronic device 208 The encrypted content may be decrypted by the CDM 218 in the trusted execution environment 220 using the decryption key obtained from the selected broadcast DRM message.

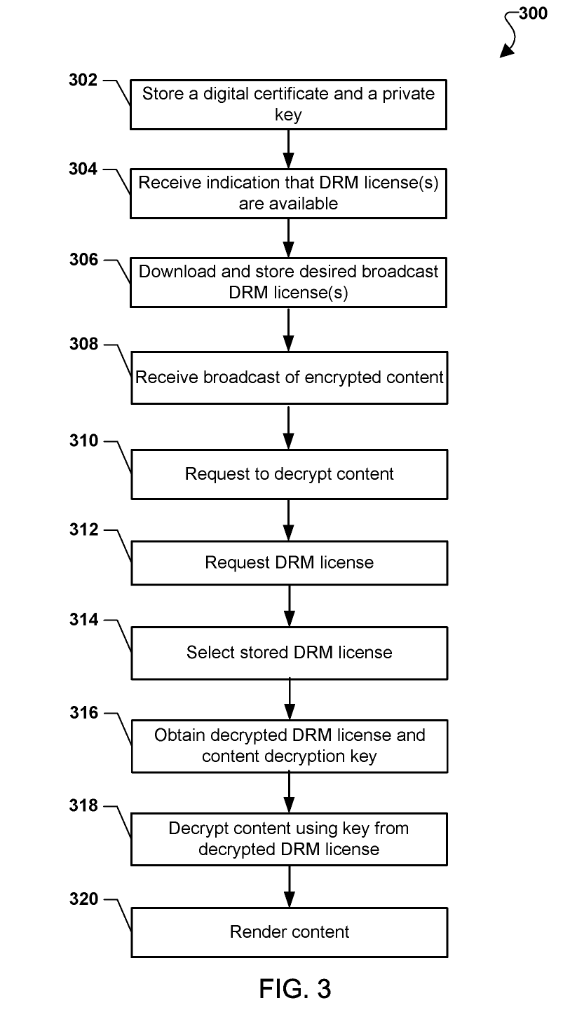

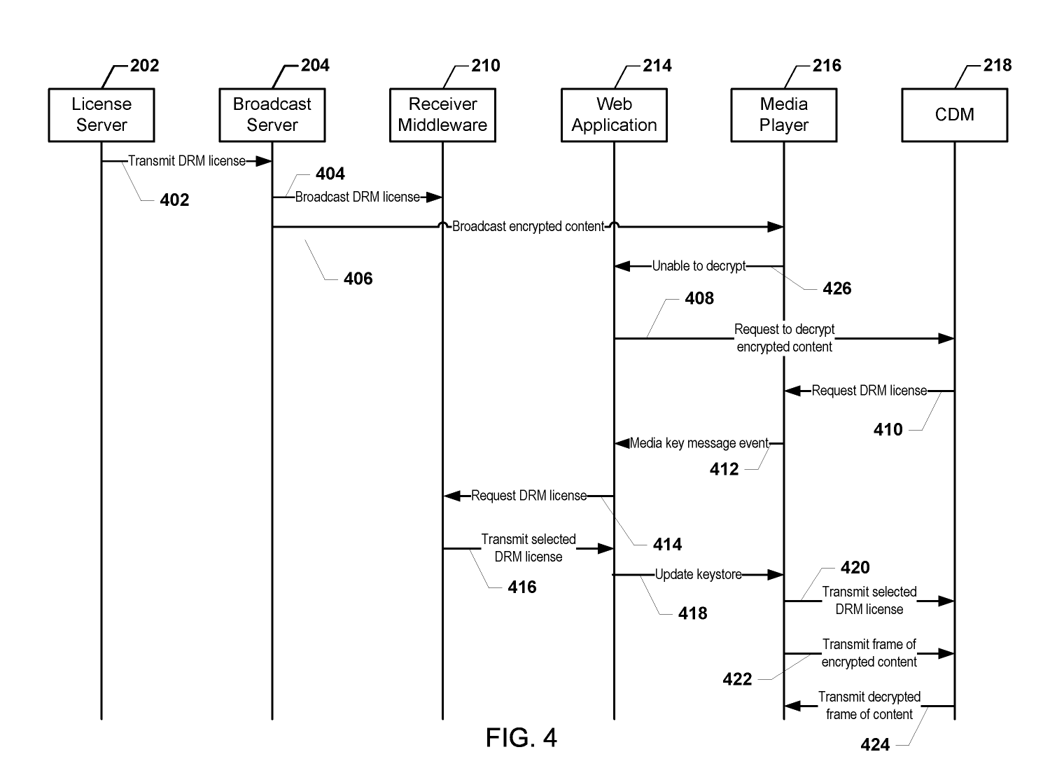

FIGS. 3 and 4 illustrate an embodiment method for rendering encrypted content received by a receive-only device. FIG. 3 illustrates a flow diagram of an embodiment method for rendering encrypted content received by the receive-only device (e.g., receive-only electronic device 208). FIG. 4 illustrates a signal flow diagram for an embodiment method for rendering the encrypted content received by the receive-only device 208.

As illustrated in FIG. 3, block 302, a digital certificate and private key associated with the digital certificate is stored by the receive-only device 208. In various embodiments, the digital certificate certifies the trustworthiness of the device and may include private and public keys that may be used in decrypting messages received from the broadcast server 204. In some embodiments, the digital certificate and the associated private key may be stored in a trusted execution environment of the receive-only device 208 or a secured memory of the receive-only device 208 during manufacturing of the receive-only electronic device 208. Alternatively or additionally, the digital certificate and associated private key may be stored in a portable memory configured to be plugged into and/or transferred to the receive-only electronic device 208. In some embodiments, the digital certificate may be known to the license server 202. In some embodiments, the license server 202 may assign the digital certificate and associated private key to each receive-only electronic device 208 for storage in memory during manufacture or in encrypted plug-in memories that may be distributed to purchasers of licenses.

A digital certificate and associated private key may be generated for each class of receive-only electronic devices 208 and stored in memory during manufacture. In some embodiments, in order to play premium content at a receive-only electronic device 208, as illustrated FIG. 4 in signal 402, the license server 202 transmits one or more DRM licenses to the broadcast server 204.

In some embodiments, the public key of the digital certificate previously provisioned in the receive-only electronic device 208 may be provided to the license server 202 where the certificate corresponds to a classification type of the receive-only electronic device 208. Different classifications of receive-only electronic devices 208 may be licensed to a manufacturer (e.g., Samsung™ Sony™, LG™, etc.), a model classification of a manufacturer, and/or a unique device identification number. For example, when the classification is associated with Sony™ TVs, the particular digital certificate associated with Sony™ TVs, and stored in memory during manufacture, may be encrypted with the public key of the digital certificate for the Sony™ classification of TVs. In some embodiments, the license server 202 may sign the digital certificates for each receive-only electronic device 208 rather than a consumer electronics (CE) manufacturer or, for example, a Sony™ device capable of receive-only operation.

In some other embodiments, the public key of the digital certificate previously provisioned in the receive-only electronic device 208 may be provided to the license server 202 where the certificate corresponds to a group of receive-only electronic devices 208 associated with a subscription identifier. The subscription identifier uniquely identifies a collection of services subscribed by the end user. Different manufacturers' receive-only capable electronic devices 208 may belong to such as device group associated with a given subscription identifier.

In yet some other embodiments, the public key of the digital certificate previously provisioned in the receive-only capable electronic device 208 may be provided to the license server 202 where the certificate corresponds to a unique, receive-only electronic device 208. Such device-specific certificate may be bound to, for example the serial number of the receive-only electronic device 208 assigned at the time of manufacturing.

In yet some other embodiments, the web application 214 passes the license request message including associated data and license server URI through a WebSocket connection to the receiver middleware 210, and the receiver middleware passes the license response message and associated data to the web application as necessary.

As illustrated in FIG. 4 signal 404, the broadcast server 204 broadcasts the DRM license where the DRM license may be encrypted using the public key for the classification type associated with the receive-only electronic device 208 such that the DRM license is delivered over the air to the receive-only electronic device 208 where the stored digital certificate and associated private key may be used to decrypt the encrypted pair of the DRM license and the content decryption key attached to that license. The DRM license may also be authenticated over the complete DRM license and encrypted over keys or other secured fields.

The DRM license may be transmitted or delivered to the receive-only electronic device 208 using various techniques. For example, the DRM license may be transmitted as a file such as a non-real time (NRT) file or embedded within signaling of broadcast content. In some embodiments, the DRM license may be carried jointly with link level signaling in a “signaling PLP” which can be a more robust physical layer delivery pipe scheduled so as to enable a system Random Access Point (RAP).

The method of delivery of the DRM license may correspond to the protocols implemented in the system. For example, when eMBMS/enTV is implemented, the DRM license may be scheduled to be transmitted at times defined by the fileSchedule element in the Schedule Description metadata fragment where the Schedule Description metadata fragment corresponds to a User Server targeted to the receive-only electronic device 208 not the user of the receive-only electronic device 208. Alternatively, when ATSC 3.0 is implemented, the times in which the DRM licenses are scheduled may be defined by the Distribution Window Description (DWD) fragment of the Service Layer Signaling (SLS).

In the case in which ATSC 3.0 is implemented, the DRM licenses may be distributed or delivered to a receive-only electronic device using at least three alternative broadcast messages where each of the alternative broadcast messages may include one or more broadcast DRM license-related messages. In some embodiments, the each of the broadcast DRM license-related messages may include a LicenseGrant message and/or a LicenseRevocation message.

For example, the one or more broadcast DRM license-related messages may be distributed in a broadcast message including service level signaling where the LicenseGrant message and/or the LicenseRevocation message may be embedded as metadata within the service level signaling. In some embodiments, the service level signaling may include a DWD fragment where the LicenseGrant message and/or the LicenseRevocation message may be embedded in the DWD fragment. In another embodiment, the service level signaling may include a DASH MPD where the LicenseGrant message and/or the LicenseRevocation message may be embedded in the MPD.

Alternatively, the one or more broadcast DRM license-related messages may be distributed in a broadcast message including an NRT file where the LicenseGrant message and/or the LicenseRevocation message may be NRT file objects included in the NRT file of the broadcast message. In some embodiments, a delivery schedule of the broadcast message may be included in a separate broadcast message. For example, the separate broadcast message that may include the delivery schedule of the broadcast message may be service level signaling including a DWD fragment where the information associated with the delivery schedule of the broadcast message may be embedded in the DWD fragment.

In another embodiment, the one or more broadcast DRM license-related messages may be delivered as NRT files via ROUTE/FLUTE or via an XML file in ALP signaling. For example, a LicenseGrant message may comprise a ROUTE NRT file including information on a granted DRM license and an associated content decryption key. A LicenseRevocation message may comprise a ROUTE NRT file including information on a revoked set of one or more DRM licenses and associated content decryption keys. The information on the revoked set of one or more DRM licenses and associated content decryption keys may be a list of one or more DRM licenses and associated content decryption keys that have been revoked and are no longer valid. Alternatively, the information on the revoked set of one or more DRM licenses and associated content decryption keys may be a list of one or more DRM licenses and associated content decryption keys that are still valid where the electronic device may determine that any DRM licenses and associated content decryption keys that are not included in the LicenseRevocation message are no longer valid. In some embodiments, when the LicenseGrant message and/or the LicenseRevocation message is a ROUTE NRT file, the ROUTE NRT file may be indexed by an Extended file delivery table ((E)FDT). Alternatively, the LicenseGrant message and/or LicenseRevocation message may comprise a FLUTE NRT file including information on a granted DRM license and an associated content decryption key or information on a revoked set of one or more DRM licenses and associated decryption keys, respectively. In some embodiments, when the LicenseGrant message and/or the LicenseRevocation message is a FLUTE NRT file, the FLUTE NRT file may be indexed by a file delivery table (FDT).

For example, Table 1 below illustrates how the DWD fragment of the ATSC 3.0 SLS, as defined in A/337, which is expected to be merged into A/331, may be extended to carry the LicenseGrant and LicenseRevocation messages.

TABLE 1

| Element Name | Cardinality | Data Type | Description |
|---|---|---|---|
| DWD | 1 | | |
| DistributionWindow | 1 . . . N | | Broadcast transmission time frame(s) of |
| | | | application-related files. |
| @appContentLabel | 0 . . . 1 | unsignedInt | A label or alias for the application-related files(s) |
| | | | delivered during an instance of |
| | | | DistributionWindow element. Distribution |
| | | | Window Instances identified by the same value |
| | | | of the @appContentLabel attribute |
| | | | shall transmit the same |
| | | | application-related file(s). |
| @startTime | 1 | dateTime | Start time of the parent instance of |
| | | | DistributionWindow element |
| @endTime | 1 | dateTime | End time of the parent instance of |
| | | | DistributionWindow element |
| @lctTSIRef | 1 | dwd:listOfUnsigned | A space-separated list of TSI value of the LCT |
| | | Int | channel in which the application-related files |
| | | | are delivered, during the parent instance of |
| | | | DistributionWindow element |
| AppContextId | 0 . . . N | anyURI | Defines the Application Context Identifier for this |
| | | | set of Distribution Window Filter Codes. |
| @dwFilterCode | 0 . . . 1 | dwd:listOfUnsigned | A space-separated list of unsigned integers |
| | | Int | associated with application content item(s) to |
| | | | be broadcast during the affiliated instance of |
| | | | DistributionWindow element. |
| LicenseGrant | 0 . . . N | | Message containing permission data, content |
| | | | encryption key, and key ID which are targeted |
| | | | for reception by a specific receiver or group of |
| | | | receivers |
| @licenseGrantMessage | 1 | unsignedShort | Identifier of this LicenseGrant message |
| ID | | | |
| @drmSystemId | 1 | UUIDnumberType | Identifier of the DRM system, in the form of a |
| | | | UUID (Universally Unique IDentifier), from |
| | | | which this LicenseGrant message was |
| | | | issued |
| @encryptedLicense | 1 | string | The DRM license data including encryption key |
| AndKeyData | | | and key ID, all encrypted by the public key |
| | | | associated with the digital certificate of the |
| | | | targeted receiver or group of receivers |
| LicenseRevocation | 0 . . . N | | Message which targets for reception by a specific |
| | | | receiver or group of receivers, indication of the |
| | | | license and associated key material to be |
| | | | revoked |
| @licenseRevocMessage | 1 | unsignedShort | Identifier of this LicenseRevocation |
| Id | | | message |
| @drmSystemId | 1 | UUIDnumberType | Identifier of the DRM system, in the form of a |
| | | | UUID, from which this LicenseRevocation |
| | | | message was issued |
| @encrypLicenseRevoc | 1 | string | The DRM license revocation message data, |
| Data | | | encrypted by the public key associated with the |
| | | | digital certificate of the targeted receiver or |
| | | | group of receivers |

As another example, Table 2 below illustrates how the DWD fragment of the ATSC 3.0 SLS, as defined in A/337, which is expected to be merged into A/331, may be extended to signal the delivery schedule of LicenseGrant and LicenseRevocation messages. In this example, the license message may be tied to an individual device (e.g. a specific Sony TV set owned by customer X), or to a group of devices associated with a certain service subscription with the broadcaster.

TABLE 2

| Element Name | Cardinality | Data Type | Description |
|---|---|---|---|
| DWD | 1 | | |
| DistributionWindow | 1 . . . N | | Broadcast transmission time |
| | | | frame(s) of application-related files. |
| @appContentLabel | 0 . . . 1 | unsignedInt | A label or alias for the application- |
| | | | related file(s) delivered during an |
| | | | instance of |
| | | | DistributionWindow element. |
| | | | Distribution Window instances |
| | | | identified by the same value of the |
| | | | @appContentLabel attribute |
| | | | shall transmit the same |
| | | | application-related file(s). |
| @startTime | 1 | dateTime | Start time of the parent instance of |
| | | | DistributionWindow element |
| @endTime | 1 | dateTime | End time of the parent instance of |
| | | | DistributionWindow element |
| @lctTSIRef | 1 | dwd:listOfUnsignedInt | A space-separated list of TSI value |
| | | | of the LCT channel in which the |
| | | | application-related and/or DRM |
| | | | license message files are |
| | | | delivered, during the parent |
| | | | instance of |
| | | | DistributionWindow element |
| AppContextId | 0 . . . N | anyURI | Defines the Application Context |
| | | | Identifier for this set of Distribution |
| | | | Window Filter Codes. |
| @dwFilterCode | 0 . . . 1 | dwd:listOfUnsignedInt | A space-separated list of unsigned |
| | | | integers associated with |
| | | | application content item(s) to be |
| | | | broadcast during the affiliated |
| | | | instance of |
| | | | DistributionWindow element. |
| DRMLicenseMessage | 0 . . . N | | DRM license-related message(s) |
| | | | delivery (e.g., a “LicenseGrant” or |
| | | | “LicenseRevocation”) |
| @drmSystemId | 1 | UUIDnumberType | Identifier of the DRM system, in the |
| | | | form of a UUID (Universally Unique |
| | | | IDentifer), from which this DRM |
| | | | license message is issued. |
| @licenseMessageId | 1 | unsignedInt | Identifier of this DRM license-related |
| | | | message, If the same message is |
| | | | sent during multiple Distribution |
| | | | Window instances, they shall have |
| | | | the same @licenseMessageId |
| | | | value. |
| @subscriptionId | 0 . . . 1 | subscriptionIdType | Identifier of the service subscription |
| | | | and hence device group to which |
| | | | this DRM-related license message |
| | | | is addressed. |
| @deviceId | 0 . . . 1 | deviceIdType | Identifier of the unique device to |
| | | | which this DRM license-related |
| | | | message is addressed. |

In some embodiments, the DWD may be designed to announce the broadcast schedule of the NRT files such as broadcaster application files. As shown in Table 1, this fragment is extended to carry an encrypted and possibly authenticatable DRM license granting and revocation messages which are not bound to broadcaster applications but to the streaming media for which DRM protection is applied. The LicenseRevocation message may include a certificate revocation list (CRL) which may indicate the license(s) that have been revoked. In some embodiments, the receive-only electronic device may be required to periodically download the LicenseRevocation message to continuously verify whether a previously granted license is still valid.

In some embodiments, the public key portion of the DRM license may be delivered as an NRT file. For example, the file may be delivered as a unidirectional transport (FLUTE) filed indexed by a file delivery table (FDT). As another example, the NRT file may be a real-time object delivery over unidirectional transport (ROUTE) file where a ROUTE file mode may be used to deliver license messaging. The license messaging may be indexed by the (Extended) FDT ((E)FDT or EFDT). In some embodiments, the LicenseRevocation and LicenseGrant messages may be delivered as the following NRT files:

<File

Content-Location=″http://someURI/licenseGrant″
TCI-“x″
Content-Length=“y″
Content-Type-“NewLicenseGrant_MIME″
Content-MD5=“ddd”
Hash-alg = “SHA-something”
LMIIash=“zzz″/>

<File

Content-Location=″http://someURI/licenseRevoke″
TCI-“x″
Content-Length=“y″
Content-Type-“NewLicenseRevoke_MIME″
/>

As illustrated by the NRT files above, the EFDT attributes may be extended to cover the message type. For example, the “Content-Type” elements may identify a message type by Multipurpose Internet Mail Extensions (MIME). Alternatively, an existing “application/octet” MIME type element and an identify message using content location may be used.

In some embodiments, an expected license message hash may be provided such that a proxy (e.g., receiver middleware 210) may validate a message from the CDM 218 where the hash algorithm may be specific to the DRM system. For example, “schemeIdURI”, as defined by the DASH Industry Forum (e.g., DASH IOP v. 3) may be specified as an (E)FDT extension attribute to provide UUID information for the DRM system. In addition, “default KID” as defined by DASH IF may also be specified as an (E)FDT extension attribute to indicate to the receiver middleware 210 whether a previously downloaded LicenseGrant message is still valid.

In some embodiments, for either eMBMS/enTV or ATSC 3.0 broadcast transmission of DRM-protected DASH streaming content, a license object may be embedded directly in the media presentation description Q. For example, by extending the @value attribute of the ContentProtection Descriptor to include the encrypted and possibly authenticatable license file where the @schemeIdUri attribute identifies the DRM system described by this ContentProtection Descriptor.

In some examples, the DRM license may be broadcast and delivered according to a defined schedule where the receive-only electronic device 208 may determine the defined schedule using information included in the DRM license messages. For example, the defined schedule may be signaled by the above described DWD fragment. It is desirable for the DRM license messages to be delivered according to a known schedule to avoid carousel delivery of the DRM license messages.

As illustrated in FIG. 3, in operation 304, the receive-only electronic device 208 may receive an indication that a DRM license is available to be downloaded to the receive-only electronic device 208. For example, based on the information included in the DRM license message broadcast from the broadcast server 204, the receive-only electronic device 208 may determine whether the DRM license may be used by the receive-only electronic device 208 in conjunction with the digital certificate and associated private key stored in memory of the receive-only electronic device 208 to obtain the content encryption key where the content encryption key may decrypt encrypted content to be rendered by the receive-only electronic device 208.

In some embodiments, the receiver middleware 210 may use the service signaling associated with the broadcasted DRM license message, such as the User Service Description in MBMS or the Service Layer Signaling in ATSC 3.0, to gain awareness of the broadcast license delivery as NRT files in order to determine whether to download and cache the DRM license message.

As illustrated in FIG. 3, block 306, the receive-only electronic device 208 may download and store one or more of the DRM license messages broadcast by the broadcast server 204. In some embodiments, the receive-only electronic device 208 may determine whether each DRM license message is a candidate for download based on the information included in the broadcast DRM messages. In some examples, the information included in the broadcast DRM license messages used to determine whether the DRM license is a candidate for download may be associated with digital certificate and associated private key stored in secure memory on the receive-only electronic device 208. Additionally or alternatively, identification information may be communicated in a URI included in the broadcast DRM license messages. The receive-only electronic device 208 may use the information associated with the URI to determine whether to download the broadcast DRM license message as well as how to classify or identify the broadcast DRM license message after the DRM license message is stored in a memory of the receive-only electronic device 208. In some embodiments, the receive-only electronic device 208 may use the URI information to classify the DRM license message in order to more easily select a DRM license when the CDM requests a DRM license. In some examples, the URI may include identifier information associated the license server 202, the broadcast server 204, and/or the encrypted content.

In some embodiments, the receiver middleware 210 may choose to only cache the DRM licenses messages appropriate to its device model by virtue of filtering on the license label representing metadata for the license object. In some embodiments, license label metadata may be carried as an FDT extension parameter or as an additional parameter in the service signaling fragment which describes the transmission of the license object. In an exemplary embodiment, the license label may include a device identifier such as the one reproduced below:

<File

Content-Location=″http://someURI/licenseGrant″
TOI=“x″
Content-Length=“y″
Content-Type=“NewLicenseGrant_MIME″
Content-MD5=“ddd”
Hash-alg = “SHA-something”
LMHash=“zzz″
PKHash=”abcde”/>

<File

Content-Location=″http://someURI/licenseRevoke″
TOI=“x″
Content-Length=“y″
Content-Type=“NewLicenseRevoke_MIME″
PKHash=”abcde”/>

However, other forms of device identifiers may be implemented. As illustrated in FIG. 3, block 308 and FIG. 4, signal 406, the broadcast server 204 may broadcast the encrypted content from a content server, and receive-only electronic devices 208 may receive such content. In some embodiments, the broadcast encrypted content may be received in the receiver middleware 210 of the receive-only electronic device 208 and then passed to a media player 216 via the web application 214. The media player 216 may determine whether or not the content is configured to be rendered based on the broadcast content. In response to determining that the content is encrypted and unable to be rendered, the media player 216 may notify the web application 216 that the media player is unable to decrypt the content in signal 426.

In response to receiving the notification that the media player is unable to decrypt the content, the web application 214 may request that the encrypted content be decrypted by the CDM as illustrated in FIG. 3, block 310 and signal 408. In some embodiments, the web application 214 may forward information included in the broadcast encrypted content to the CDM where the CDM may generate a request for a DRM license based on the information included in the broadcasted encrypted content forwarded from the web application 214. For example, the information included in the broadcasted encrypted content that is forwarded to the CDM may include information that uniquely identifies a DRM license server and/or the target device. For example, the identifiers may indicate a device group, a DRM provider (e.g., license server), and/or applicable equipment. The identifier information may be formatted as a URI to allow identifier information to be communicated using the standard methods within the existing protocols and standards. In some examples, the receiving device may use the identifier information included in the URI to determine which broadcast DRM licenses to download to the receive-only device. In addition, the CDM may extract information of a license server corresponding to the encrypted content and then generate a request for a DRM license and address the request for the DRM license to the license server corresponding to the encrypted content. The receiver middleware may then select a stored DRM license based on the license server identifier included in the request for a DRM license received from the CDM.

For example, the CDM may generate a request for a DRM license using the URI associated with the identifier information included in messages received from the broadcast server in order to decrypt DRM-protected content. In some examples, the CDM may generate the request for the DRM license in response to receiving a request from a media player (e.g., in a web runtime engine) that has encountered encrypted content that it cannot play. In some examples, the request for the DRM license and/or response to the request for the DRM license may be formatted using the HTTP scheme such that the CDM makes an HTTP request for license/key material, and after intercepting the HTTP request generated by the CDM, the receiver middleware may return the appropriate cached license/key to the CDM via the app and media player.

In some embodiments, the identifiers may be carried in either the ‘pssh’ box in the ‘moof’ of the ISO BMFF container (i.e., when the encrypted content is distributed using in-band delivery) or in the ContentProtection descriptor in the DASH MPT (i.e., when the encrypted content is distributed using out-of-band delivery).

The CDM 218 may request a DRM license in response to receiving the request to decrypt content as illustrated in FIG. 3, block 312 and FIG. 4, signal 410. The CDM 218 may use the license server identifier to generate the request for a DRM license. In some embodiments, the CDM 218 may use the ‘pssh’ or ContentProtection Descriptor to issue a license request to the request target given by the license server URI.

In some embodiments, the CDM 218 may format the request for the DRM license in a way that will match the value of the ‘Content-Location’ attribute of one of the FDTs/EFDTs associated with the broadcast license files. For instance, the information of the FDT/EFDT associated with the ‘Content-Location’ value matches the request URI may be used to identify the license object (described by the FDT/EFDT) that the receiver middleware 210 may deliver to the CDM 218 via the web application 214. One or more URIs included in the DRM license request may identify the DRM system, the unique device or group of devices to which the license applies, applicable equipment, type of media included in the encrypted content, etc. or a combination thereof.

The DRM license request may be a Uniform Resource Locator (URL) that includes identifier information having the following generic structure: http(s)://hostname.domain|path?query. For example, “hostname.domain” may be a URI that includes information indicating the hostname of the license server followed by the domain name identifying the administrative domain that owns the DRM system and the associated license server. The “path” may be a URI that includes information indicating the target device (i.e., user agent/browser) for license acquisition and usage. The “query” may be a URI that includes information indicating the device group or the unique device to which the license applies. An exemplary URL and equivalently, FDT/EFDT ‘Content-Location’ corresponding to the license object to be retrieved by the request may be:

https://widevine1.google.com/chrome?device=sony&class=atsc3

In some examples, DRM license or key delivery may be adapted to match the media application (e.g., type of media included in the encrypted content). For example, NRT DRM licenses may be delivered as NRT objects potentially supported by DWD delivered scheduling information. In addition, unit addressed license delivery may also be supported. Additionally or alternatively, a DRM license may be delivered as part of a streaming media RAP. While unit addressed license delivery may be implemented using the streaming media RAP, alternative methods may be preferred. In some examples, streaming license delivery may be accomplished via NRT file delivery in the Service RAP or in XML object delivery in ALP which is normally reserved for signaling.

As illustrated in FIG. 4, signal 412, the request for the DRM license 410 may be transmitted from the media player 216 to the web application using a media key message event 412, and the web application 214 may communicate the request for the DRM license to the receiver middleware 210 in signal 414. In some embodiments, the receiver middleware 210 acts as a HTTP proxy and intercepts the license request transmitted from the CDM 218 via a browser of the web application 214.

As illustrated in FIG. 3, block 314, the receiver middleware 210 may select a stored DRM message received from the broadcast server 204 in signal 404. In some embodiments, the receiver middleware 210 may match values between the file URI (‘Content-Location’) attribute in the FDT/EFDT of the encrypted and possibly authenticatable license object and the requested target included in the request for the DRM license. The receiver middleware 210 may identify an encrypted and possibly authenticatable license of interest included in one of the stored DRM messages received from the broadcast server based on the information included in the request for the DRM license.

After a stored DRM message is selected, the DRM license associated with the DRM message may be transmitted from the receiver middleware 210 to the CDM 218 via the web application 214 and the media player 216. Specifically, the receiver middleware 210 may transmit the selected DRM license to the web application in signal 416 of FIG. 4. The web application 214 may then update the keystore in signal 418 to reflect the selected DRM message as the selected DRM license is transmitted to the media player 216. Finally, the media player may transmit the selected DRM license to the CDM 218 in signal 420.

As illustrated in block 316 of FIG. 3, the CDM 218 may decrypt the selected DRM license message to obtain the content decryption key and the decrypted DRM license. For example, the CDM 218 may use the private key and the digital certificate stored in the receive-only electronic device 208 during the initial provisioning to decrypt the selected DRM license. In some embodiments, the CDM may be located within a trusted execution environment (e.g., trust zone) to prevent any undesirable security risk. Since the private key and digital certificate stored during the initial provisioning of the receive-only electronic device 208 are also stored in the trusted execution environment, the CDM 218 may decrypt the selected DRM message and extract an embedded content key and associated key ID using the private key of the device group certificate without incurring any security risk that this data may be easily obtained by a rogue application which may result in subsequent content theft.

As illustrated in FIG. 4, signal 422, the media player 216 transmits encrypted content to the CDM for decrypting. For example, the media player 216 may transmit a frame of the encrypted content to the CDM 218 where the CDM 218 may decrypt the frame of the encrypted content using the extracted content key as illustrated in block 318 of FIG. 3. As illustrated in signal 424, the decrypted frame of content is then transmitted to the media player 216 where the media player in the browser sends the information associated with the decrypted content to be rendered such that the encrypted content is rendered on a render of the receive-only electronic device 208 as illustrated in block 320.

While it may be possible to decrypt the broadcast DRM messages outside of a trusted execution environment, such decryption would require that the secret information of the private key as well as the corresponding device certificate be communicated in an environment that may allow for the secret information and/or encrypted content to be stolen and distributed without authorization by a rogue application. In addition, there is no need to introduce an additional hash code to identify the target device as contemplated in the MPEG DASH or MPEG media transport (MMT) specifications.

One benefit of the above described methods is that no modifications, revisions, or additions to existing standards or protocol specifications is necessary because the existing metadata structures, parameters, and/or messaging may be implemented to carry out the methods described herein.

Various examples of different server devices, personal devices, and protocols are discussed herein, such as eMBMS/enTV, ATSC 3.0, MPEG MMT, MPEG DASH, and MMT. The discussions of specifically eMBMS/enTV, ATSC 3.0, MPEG MMT, MPEG DASH, and MMT are provided merely as examples to better illustrate the aspects of the various embodiments, and are not intended to limit the various embodiments in any way. Other gateways, personal devices, and protocols may be used with the various embodiments, and the other gateways, personal devices, and protocols may be substituted in the various examples without departing from the spirit or scope of the invention.

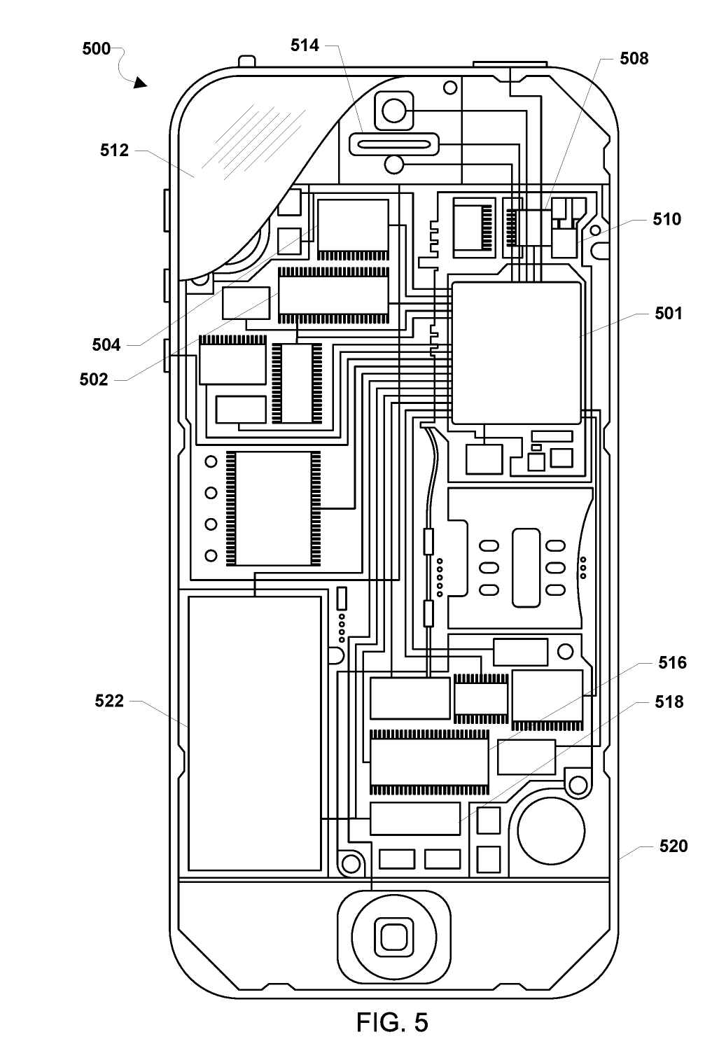

The various embodiments (including, but not limited to, embodiments discussed above with reference to FIGS. 1-4) may be implemented in any of a variety of personal devices (i.e., receive-only electronic devices), an example of which is illustrated in FIG. 5. For example, the personal device 500 may include a processor 501 coupled to a touch screen controller 504 and an internal memory 502. The processor 501 may be one or more multicore integrated circuits (ICs) designated for general or specific processing tasks. The internal memory 502 may be volatile or non-volatile memory, and may also be secure and/or encrypted memory, or unsecure and/or unencrypted memory, or any combination thereof. The touch screen controller 504 and the processor 501 may also be coupled to a touch screen panel 512, such as a resistive-sensing touch screen, capacitive-sensing touch screen, infrared sensing touch screen, etc.

In some embodiments, the personal device 500 may operate in a unicast mode as well as a receive-only mode. Therefore, personal device 500 may include one or more radio signal transceivers 508 (e.g., Peanut®, Bluetooth®, Zigbee®, Wi-Fi, cellular, etc.) and antennae 510, for sending and receiving, coupled to each other and/or to the processor 501. The transceivers 508 and antennae 510 may be used with the above-mentioned circuitry to implement the various wireless transmission protocol stacks and interfaces. The personal device 500 may include a cellular network wireless modem chip 516 that enables communication via a cellular network and is coupled to the processor.

The personal device 500 may include a peripheral device connection interface 518 coupled to the processor 501. The peripheral device connection interface 518 may be singularly configured to accept one type of connection, or multiply configured to accept various types of physical and communication connections, common or proprietary, such as USB, FireWire, Thunderbolt, or PCIe. The peripheral device connection interface 518 may also be coupled to a similarly configured peripheral device connection port (not shown).

The personal device 500 may also include speakers 514 for providing audio outputs. The personal device 500 may also include a housing 520, constructed of a plastic, metal, or a combination of materials, for containing all or some of the components discussed herein. The personal device 500 may include a power source 522 coupled to the processor 501, such as a disposable or rechargeable battery. The rechargeable battery may also be coupled to the peripheral device connection port to receive a charging current from a source external to the personal device 500.

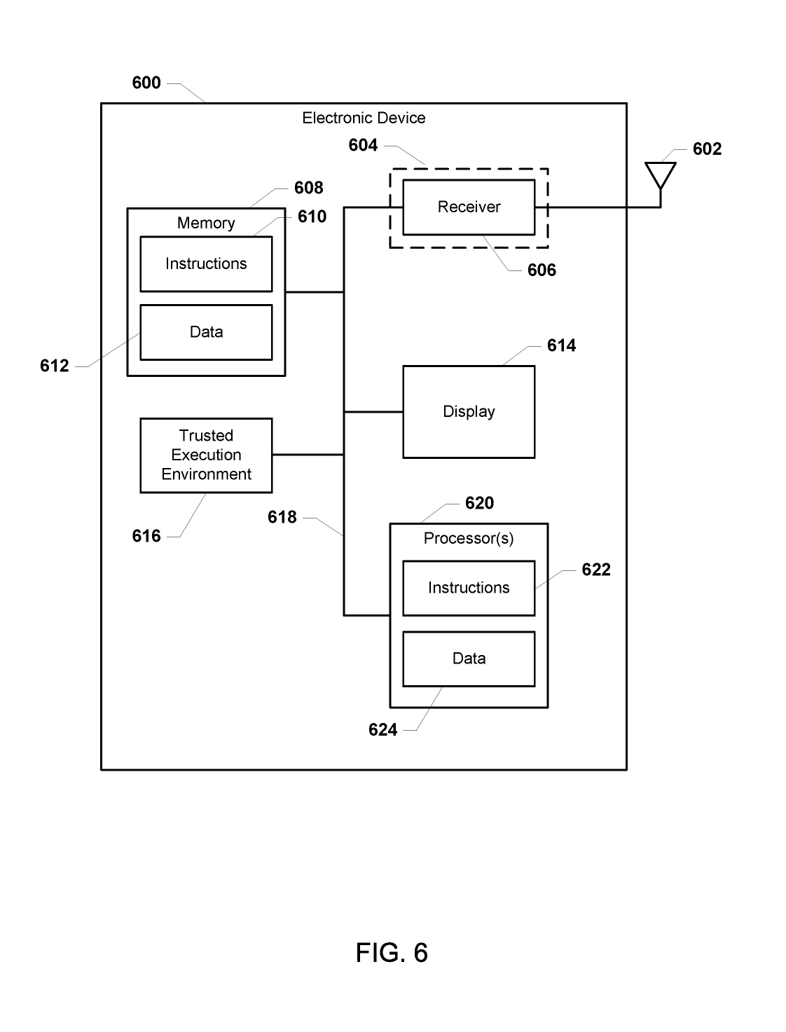

FIG. 6 is a component block diagram illustrating components that may be included within a receive-only electronic device configured to implement various configurations of the systems and methods of rendering encrypted content. Examples of the receive-only electronic device 600 may include a television, a display device, a cellular phone, a smartphone, a computer (e.g., a desktop computer, a laptop computer, etc.), a tablet device, etc. One or more of the components or elements of the receive-only electronic device 600 may be implemented in hardware (e.g., circuitry) or a combination of hardware and software (e.g., at least one processor with instructions). The receive-only electronic device 600 may be implemented in accordance with the receive-only electronic devices 114, 116, 208, and 500. The receive-only electronic device 600 may include a processor 620, which may be a general purpose single-chip or multi-chip microprocessor (e.g., an ARM), a special purpose microprocessor such as digital signal processor (DSP).

The electronic device 600 may also include memory 608 coupled to the processor 620. The memory 608 may be any electronic component capable of storing electronic information. The memory 608 may be embodied as random access memory (RAM), read-only memory (ROM), magnetic disk storage medial, optical storage media, flash memory devices in RAM, on-board memory included with the processor, EPROM memory, EEPROM memory, registers, and so forth including combinations thereof.

Data 610 and instructions 612 may be stored in the memory 608. The instructions 612 may be executable by the processor 620 to implement one or more of the methods (e.g., methods 300), procedures, steps, and/or functions described herein. Executing the instructions 610 may involve the use of the data 612 stored in the memory. When the processor 620 executes the instructions 610, various portions of the instructions 622 may be loaded onto the processor 622 and/or various pieces of data 624 may be loaded onto the processor 620.

The receive-only electronic device 600 may include a trusted execution environment 616. The trusted execution environment 616 may include one or more processors and/or memory to perform secure operations that are masked from the rest of the elements of the receive-only electronic device 600. For example, the trusted execution environment 616 may include a DRM client or agent such as a CDM in order to perform operations in a secure environment to reduce the risk of undesired interception of secure data.

The electronic device 600 may also include a communication interface 604 including a receiver 606 to allow reception of signals by the receive-only the electronic device 600. One or more antennas 602 may be electrically coupled to the communication interface 604. The receive-only electronic device 600 may also include (not shown) multiple transmitters, multiple receivers, multiple transceivers and/or additional antennas if the receive-only electronic device 600 is configured to operate in a unicast mode as well as the receive-only mode.

The receive-only electronic device 600 may also include a display 614 configured to display the encrypted content after the encrypted content has been decrypted by the receive-only electronic device 600. While not illustrated, the receive-only electronic device 600 may include one or more input or output devices configured to allow and/or enable one or more kinds of input and/or output. For example, the receive-only electronic device 600 may include a communication interface having one or more ports to establish communication links with other devices. In some configurations, the communication interface may include a transmitter, a receiver, or both (e.g., a transceiver). Additionally or alternatively, the receive-only electronic device 600 may include one or more other interfaces (e.g., touchscreen, keypad, keyboard, microphone, camera, etc.) and/or television band tuners to allow the receive-only electronic device 600 to tune into different television channel broadcasts and/or different service provider broadcasts. The receive-only electronic device 600 may also include one or more sensor(s). The one or more sensor(s) may include a proximity sensor, an ambient light sensor, an accelerometer, a near field communication sensor, a gyroscope, a magnetometer, a temperature sensor, a barometric pressure, a color sensor, an ultraviolet sensor, a Global Positioning System (GPS) sensor, etc.

The various components of the electronic device 600 may be coupled together by one or more buses, which may include a power bus, a control signal bus, a status signal bus, a data bus, etc. For the sake of clarity, the various buses are illustrated in FIG. 6 as a bus system 618.

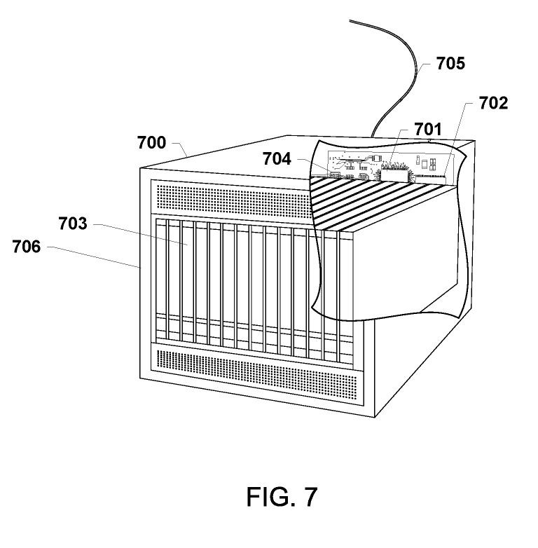

Various embodiments (including, but not limited to, embodiments described with reference to FIGS. 1-4) may also be implemented on any of a variety of server devices, an example of which (e.g., license servers 102 and 202, broadcast servers 104 and 204, content servers 106 and 206) is illustrated in FIG. 7. With reference to FIGS. 1-4 and 7, the server device 700 typically includes a processor 701 coupled to volatile memory 702, and may also include and a large capacity nonvolatile memory, such as a disk drive 704. The server device 700 may also include a floppy disc drive, compact disc (CD) or DVD disc drive 706 coupled to the processor 701. The server device 700 may also include network communication ports 703 coupled to the processor 701 for, among other things, establishing network interface connections with a communication network 704 (such as a local area network coupled to other broadcast system computers and servers, a wide area network, a content data network, the public switched telephone network, and/or a cellular data network (e.g., CDMA, TDMA, GSM, PCS, 3G, 4G, LTE, or any other type of cellular data network). The server device 700 may also include output ports for providing content to a receive-only electronic device, and/or providing content to an output device, such as a display and/or a speaker (not shown).

The processors 501, 620, and 701 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory before they are accessed and loaded into the processors 501, 620, and 701. The processors 501, 620, and 701 may include internal memory sufficient to store the application software instructions. In many devices, the internal memory may be a volatile or nonvolatile memory, such as flash memory, or a mixture of both. For the purposes of this description, a general reference to memory refers to memory accessible by the processors 501, 620, and 701 including internal memory or removable memory plugged into the device and memory within the processors 501, 620, and 701 themselves.

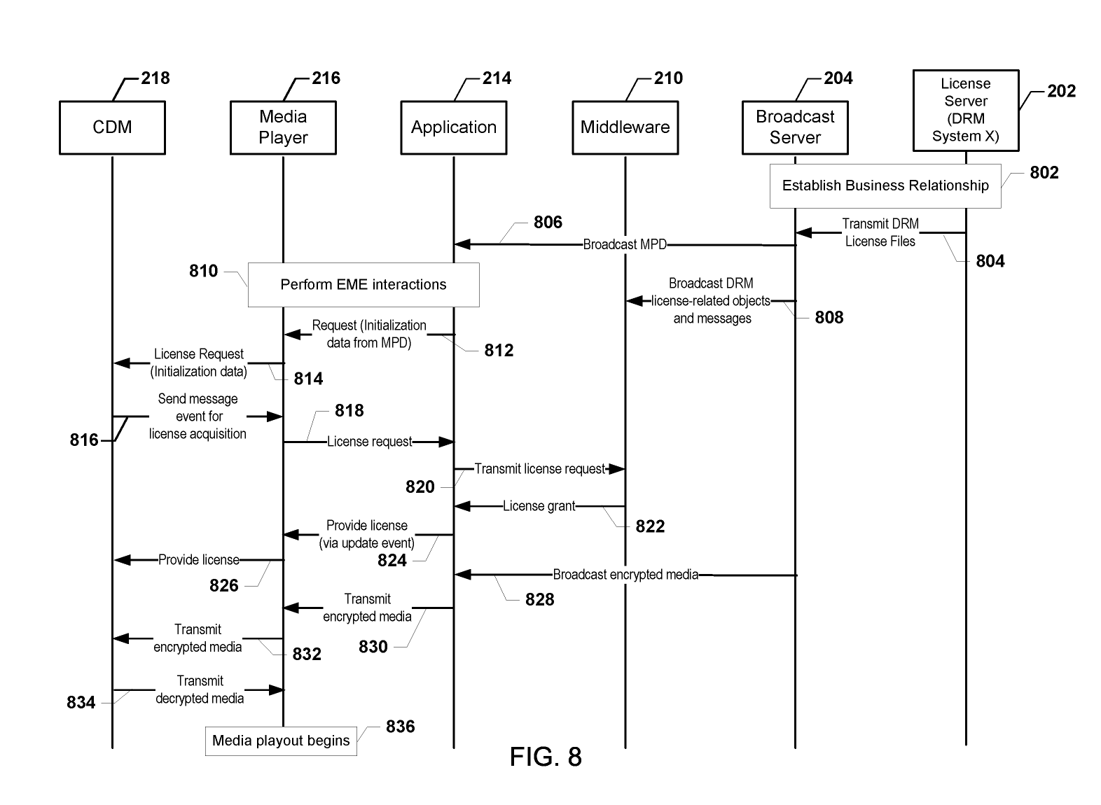

FIG. 8 illustrates a signal flow diagram for an embodiment method for rendering encrypted content received by an electronic device operating in a receive only mode, such as within a receive-only electronic device 208.

As illustrated in FIG. 8, the license server 202 and the broadcast server 204 may establish a business relationship in block 802. In some embodiments, the license server 202 may be associated with a DRM System X. This business relationship may allow content and service providers with an ability to utilize digital rights management (DRM) to protect content (e.g., pay-per-view movies, concerts, and sporting events). In addition, this may allow the electronic device 208 to subscribe to receive the protected content when the electronic device 208 is operating in a receive-only mode after the electronic device 208 receives an appropriate DRM license(s). Various embodiments leverage features of existing standards such as MPEG DASH, MPEG CENC, and W3C EME to enable interoperable use of existing DRM technologies across heterogeneous device platforms by different service providers.

In signal 804, the license server 202 may transmit DRM license files to the broadcast server 204. As described above, the DRM license files may include one or more DRM licenses and a decryption key attached to each license. In some embodiments, the decryption key may be used to decrypt encrypted content. Alternatively, the decryption key may be used to decrypt other keys. One of the other keys may be used to decrypt the encrypted content. The license server 202 may provide DRM licenses to the broadcast server 204 that are assured uniqueness via one or more of an assigned DRM SystemlD, a device and/or device group identifier, and a Key ID (KID).

Depending on the type of DRM license to be issued, the broadcast server 204 may employ different license-related message delivery methods. For example, when the DRM license is intended for an individual device, the DRM license may be transmitted in a message addressed to the individual device (e.g., unit-addressed). In some embodiments, a unit-addressed message including a DRM license may be scheduled by DWD for delivery as a large number of NRT files (e.g., overnight). Alternatively, when the DRM license is intended for a group of devices (e.g., subscription-based), the DRM license may be sent as part of the RAP to enable rapid service access upon a channel change. The device unit address and/or device/device group unique identifier may be arbitrary such as a serial number assigned at the time the device is manufactured. Alternatively, the device unit address may be a hash of a device certificate or any other method that assures uniqueness. When the electronic device 208 has a group based subscription, this type of subscription requires at least one shared key for access where the at least one shared key is addressed to the group of devices that have the same set of subscribed services.

In signal 806, the broadcast server 204 may broadcast an MPD in signal 806 where the MPD is the selected license-related message delivery method illustrated in FIG. 8. However, the broadcast server 204 may broadcast one or more DRM license-related messages using various other methods as described herein. The broadcast MPD message in signal 806 may include signaling of the content encryption and key management methods that may allow the CDM 218 to determine whether the electronic device 208 is capable of playing out the content. For example, the broadcast MPD message in signal 806 may include a ContentProtection descriptor that uniquely identifies the target DRM system (e.g., “DRM System_X”), a device group, and/or a device type for receiving the DRM license. In the case when DASH-over-ROUTE or DASH-over-FLUTE is used, the MPD may be a signaling metadata fragment that is sent in the clear to the electronic device 208.

In some embodiments, the application 214 may identify whether the electronic device 208 may access the content by detecting the information included in the ContentProtection Descriptor for an associated program. The application 214 may use the detected information to determine whether the electronic device 208 may access the content. For example, the application 214 may extract the information associated with one or more of the target DRM system, the device group, and the device type from the ContentProtection Descriptor. In an alternative embodiment, when the electronic device 208 receives a broadcast message having the ISO BMFF container format, the application 214 may determine the SystemID from uuid and a KID from either the ‘pssh’ box in the ‘moov’ or ‘moof’ of the ISO BMFF container.

In various embodiments, the identifying information used by the electronic device 208 to identify whether or not the electronic device 208 may access the content may be constructed as a DRM license URI. In such embodiments, the DRM license URI may be used to identify a license that is appropriate to the related media and the receiving device (e.g., electronic device 208). The DRM license URI of the appropriate license may be encoded to indicate a device group, a DRM provider, a specific device, etc. The DRM license URI may allow the electronic device 208 to filter the DRM licenses to acquire and store according to a potential applicability to the electronic device 208.

In signal 808, the broadcast server 204 may broadcast DRM license-related objects and messages. The broadcast DRM license-related objects and messages may include a DRM system or license identifier, a message including a DRM license-related object such as a granted DRM license and corresponding decryption key or a file providing information on DRM licenses that have been revoked.

The DRM system or license identifier information may be included in a header of a message and may include information associated with a DRM system ID, a license message ID, and either a subscription ID or a device ID. The DRM license-related objects may include a LicenseGrant message and/or a LicenseRevocation message where the payload of the LicenseGrant message may include the granted DRM license and corresponding decryption key and the payload of the LicenseRevocation message may include information associated with DRM licenses that have been revoked.

The DRM license-related messages may further include information to allow the middleware 210 to verify whether the DRM license object has been transmitted from an authentic source (e.g., an entity authenticated by the Certificate Authority). This verification may enable the middleware 210 to protect against a man-in-the-middle attacker that has forged the LTK object message (e.g., using a mobile transmitter) to create a denial-of-service attack or illegitimate content playout, for example. To enable this capability, the DRM license-related messages may further include a digital certificate of the license server and a digital signature of the license server, and the middleware 210 may verify that the DRM license-related message is received from an authentic source by decrypting the digital certificate of the license server using the public key of the digital certificate stored at the electronic device. After decrypting the digital certificate of the license server, the middleware 210 may verify the digital signature of the license server using the public key associated with the digital certificate of the license server.

Broadcast of the DRM license-related objects and messages for DRM license delivery the electronic device 208 (or the device group including the electronic device 208 when the DRM license is subscription based) may be adapted to match the media application. For example, the DRM license-related messages may be broadcast and delivered as NRT objects via ROUTE optionally supported by DWD scheduling information. This method may support both unit-addressed license delivery and group licenses (e.g., a single license applicable to a collection of subscribed devices). Alternatively, a DRM license-related message may be delivered as part of a streaming media RAP. This method may support group licenses however, unit-addressed DRM license delivery may not be reasonable by this method.

In some embodiments, the DRM license-related messages may be broadcast using streaming license delivery that may be accomplished via NRT file delivery in the Service RAP or XML object delivery in ATSC Link-Layer Protocol (ALP) which is normally reserved for signaling.

The ROUTE file mode may be used to deliver the DRM license-related messaging and such messages may be indexed by the (E)FDT. When the ROUTE file mode is used to deliver the DRM license-related messages, the LicenseGrant message and/or the LicenseRevocation message may be delivered as NRT files. Exemplary NRT files associated with the LicenseGrant message and the LicenseRevocation message are reproduced below:

<File

Content-Location=″http://someURI/licenseGrant″
TOI=“x″
Content-Length=“y″
Content-Type=“NewLicenseGrant_MIME″
Content-MD5=“ddd”
Hash-alg = “SHA-something”
LMHash=“zzz“
Cert-hash=“abcd...”/>

<File

Content-

Location=″http://someURI/licenseRevoke″

TOI=“x″
Content-Length=“y″
Content-Type=“NewLicenseRevoke_MIME″
Cert-hash=“abcd...”/>

<File

Content-Location=http://someURI/serverCert”
TOI=“x”
Content-Length=“y”
Content-Type=“application/x-509-server-cert”
.../>

In the exemplary files above, the (E)FDT attributes may be extended to cover the message type. For example, the message type (e.g., LicenseGrant or LicenseRevocation) may be identified by MIME. Alternatively, an existing “application/octet” MIME type may be used where the type of message may be identified using content location. In addition, in the exemplary files above, an expected license message hash may be provided so that the middleware 210 (or DRM license proxy) of the electronic device 208 can validate a message from the CDM. The hash algorithm may be DRM system specific. A device identifier such as a device certificate hash may also be included in the NRT files. In addition, a server certificate may optionally be delivered for CDM outbound message encryption. For example, “schemeldURI” as defined by the DASH industry Forum (DASH IOP v. 4) may be added to file descriptors to provide UUID information for the DRM system. In addition, the “default KID” as defined by DASH IF may also be carried in file descriptor elements to indicate to receiver middleware whether a previously downloaded LicenseGrant message is still valid.

The DRM license messages may be delivered according to a known schedule. For example, a schedule associated with when a DRM license message may be delivered to the electronic device 208 may be signaled in a DWD fragment in order to avoid carousel delivery of such content.

The middleware 210 of the electronic device 208 may cache any potentially required license(s) received in signal 808 where the appropriate DRM licenses will later be delivered to the CDM upon request. The DRM license-related objects and messages targeted to the electronic device 208 may be downloaded by the electronic device 208 based on identifiers in the broadcast messages (e.g., DRM system or license identifier).

The electronic device 208 may filter the DRM license-related objects and messages using the identifiers. For example, when the identifier is a DRM license URI, the DRM license URI may include a unique reference to the broadcaster's server (e.g., hostname.domain). In addition, the DRM license URI may optionally include the DRM SystemID plus one of the following: a device unit address, a subscription ID (e.g., a unique ID for a collection of Services related to a group_id) or a verbatim list of globalServiceIDs. If it is possible for a broadcast station to run more than one DRM system concurrently, the DRM license URI may include the SystemID or other unique reference.

In an exemplary embodiment, when the DRM license is formatted using an HTTP scheme, the DRM license URL may have the following generic structure:

http(s)://hostname.domain/path?query

This DRM license URL may be expected to identify a “triplet” of {[DRM system], [device- or subscription-unique ID], [Key ID]} associated with the license. For example, the “hostname.domain” may contain the hostname of the license server followed by the domain name identifying the administrative domain which owns the DRM system and the associated license server, the “path” may be empty, and “query” may identify the device group or unique device, and the Key ID, to which the license applies. An exemplary DRM license URL may be:

https://widevine1.google.com?subscription_id=xyz&kid=55

After the electronic device 208 has detected the information in the ContentProtection Descriptor of the MPD in signal 806, encrypted media extensions (EME) interactions may be initiated in operation 810. For example, the application 214 may extract the DRM System ID included in the ContentProtection Descriptor of the MPD (e.g., “DRM System_X”) and EME interactions may be initiated between the application 214 and the media player 216 (or browser) to acquire information on DRM System_X (the DRM system information detected in the ContentProtection Descriptor in the MPD of signal 806). In addition, the related EME media keys, media system access, and media key session objects may be created in operation 810.

In signal 812, the application 214 may transmit a request for a DRM license associated with DRM System_X to the media player 216 where the request may be based on the initialization data included in the MPD. In signal 814, the media player 216 may forward the license request based on the initialization data included in the MPD to the CDM.

In signal 816, the CDM may send a message event for license acquisition. In some embodiments, the message event for license acquisition may be formatted in a way such that the request target which corresponds to the DRM license URL and carried in the HTTP(S) request for the DRM license from the CDM may be expected to match the value of the ‘Content-Location’ attribute of one of the FDTs/EFDTs associated with the DRM license-related objects and messages broadcast in signal 808. When a ‘Content-Location’ value in the FDT/EFDT matches the request URL, a DRM license object (described by the FDT/EFDT) corresponding to the ‘Content-Location’ value may be identified as the DRM license object that the middleware 210 should deliver to the CDM in response to the event for license acquisition of signal 816.

In signal 818, the media player 216 forwards the license request from the CDM 218 to the application 214 and in signal 820 transmits the license request to the middleware 210. In response to receiving the license request, the middleware 210 may select one of the stored encrypted DRM licenses (and corresponding decryption key) as described above.

In signal 822, the middleware 210 may transmit a license grant message including the selected encrypted DRM license to the application 214. In signal 824, the application provides the selected encrypted DRM license to the media player 216 via an update event message. The media player 216 provides the selected encrypted DRM license to the CDM in signal 826.

In response to receiving the selected encrypted DRM license, the CDM may decrypt the selected encrypted DRM license. The decrypted DRM license may define usage permissions and constraints along with content key(s) for use in decryption of broadcast streaming content. The CDM may use the digital certificate and corresponding private key stored in a secure memory of a trusted environment of the electronic device 208 to decrypt the encrypted DRM license where the CDM performs operations within the trusted environment.

In order to keep the communication of the message including the encrypted DRM license secure, application communications between the middleware 210, the application 214, the media player 216, and the CDM 218 with respect to transmitting the message including the encrypted DRM license may require compliance with a SecureContext requirement for EME. For example, compliance with the SecureContext requirement for EME may be due to the prohibition against mixed content. Since an existing WebSocket interface is defined as part of A/344: ATSC 3.0 Interactive Content, command and control WebSocket connection may be reused for license messaging. For instance, a WebSocket connection may satisfy the Secure Context requirement because the WebSocket connection is locally hosted. Thus, license-related messages may be delivered via HTTP(S) or WebSocket from a device cache instead of a network side license server. In some embodiments, the “WSPath/atscCmd” address (see Table 8.1 of A/344) may be implemented for transmission of license messaging.

In some embodiments, license messaging may be available in textual form for JSON-RPC compatibility. For example, binary data may be encoded using Base64 encoding. In an exemplary embodiment, an application binding for a license messaging request Application Programming Interface (API) using JSON-RPC formatting may be implemented as follows:

method: “org.atsc.license.message”
params: A JSON object containing the License URL and License Message
params JSON Schema:

{

“type”: “object”,
“properties”:{

“licenseURL”: {

“type”: “string”,
“format”:”uri”
},
“licenseMessage”: {“type”: “string”},
},

“required”: [“licenseURL”]
}

In addition, an application binding license event may be implemented as follows:

method: “org.atsc.notify”

params: A JSON object containing the License Server messaging to CDM
params JSON Schema:

{

“type”: “object”,
“properties”:{

″msgType″: {″type″: ″string″, ″enum″:

[“licenseServerMessaging″]},

“licenseServerMessage”: {“type”: “string”}, //see Note
“licenseServerMessageURL”: {“type”: “string”}, //see Note
“schemeIDURI”:{“type”:”string”},
“defaultKID”:{“type”:”string”},
“serverCert”:{“type”:”string”}, //see Note
“serverCertURL”:{“type”:”string”}, //see Note
},

“required”: [″msgType″]

}
Note:
serverCert and licenseServerMessage may also be retrieved by application at local URL's (as opposed to inband delivery).

In signal 828, encrypted media may be broadcast from the broadcast server 204 to the application 214. The encrypted media may be transmitted by the broadcast server 204 in one or more segments over one or more broadcast sessions. In some embodiments, the encrypted media may be broadcast via ROUTE of encrypted DASH streaming media by content key(s) of DRM System X.

The application 214 may transmit the encrypted media to the media player 216 in signal 830 and the media player 216 may forward the encrypted media to the CDM 218 in signal 832 for decryption. The CDM 218 may decrypt the encrypted media using the content key(s) included in the DRM license. The CDM 218 may transmit the decrypted media to the media player 216 in signal 834 where the media player 216 may render the decrypted media when media playout begins in operation 836. In the above described method, there are two types of media being delivered to the electronic device 208, NRT media objects which may correspond to the DRM license-related files and real time streaming media objects which may correspond to the DRM-protected content.

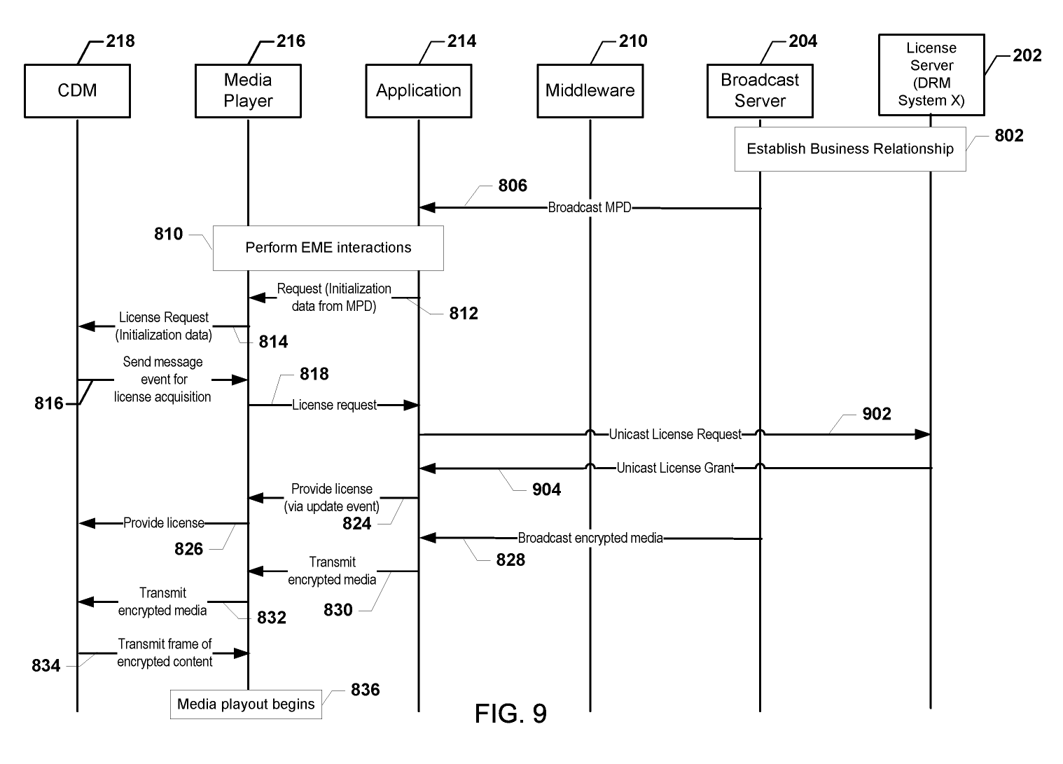

FIG. 9 illustrates a signal flow diagram for an embodiment method for rendering encrypted content received by an electronic device (e.g., electronic device 208) operating in a unicast mode. The flow call signals illustrated in FIG. 9 are generally the same as the flow call signals illustrated in FIG. 8 where the same flow call signals are referenced using the same reference numbers. The difference in flow call signals between FIG. 8 and FIG. 9 is that the broadcast DRM license-related objects and messages included in signal 808 of FIG. 8 are omitted from FIG. 9 because when the electronic device is operating is a unicast mode, the electronic device may request a specific DRM license from the license server 202.

Specifically, after receiving the license request in signal 818, the application 214 may send a unicast license request to the license server in signal 902. In response to receiving the unicast license request in signal 902, the electronic device and the license server 202 may perform authentication and authorization procedures for license granting. In signal 904, the license server may send the unicast license grant to the application 214. The unicast license grant may include an encrypted DRM license object and corresponding decryption key.

The format of the license request message in signal 818 may be the same whether the electronic device is operating in the receive-only mode or the unicast mode. Likewise, the format of the unicast license grant message in signal 904 may have the same format as the message that provides the license via the update event in signal 824. In other words, for DRM license acquisition and content decryption purposes the CDM 218 is unaware of whether the electronic device is operating in the receive-only mode or the unicast mode.

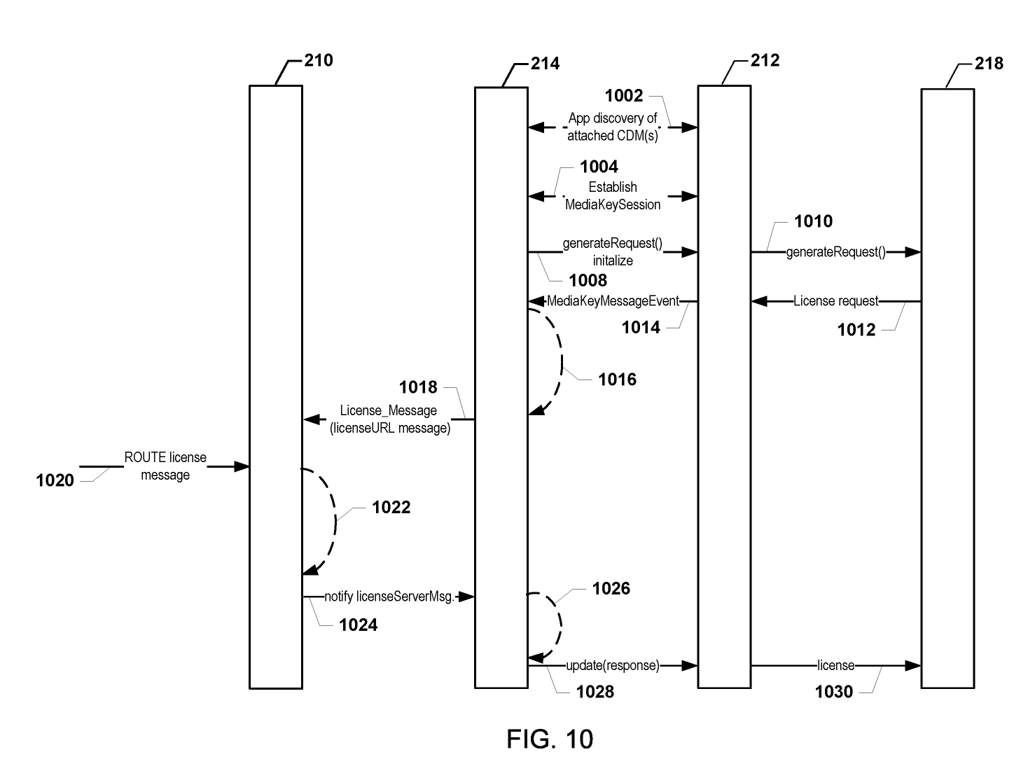

FIG. 10 illustrates a signal flow diagram for an embodiment method for obtaining a broadcast DRM license by an electronic device operating in a receive only mode (e.g., electronic device 208).

Initially, the Web Runtime Engine 215 and the application 214 of the electronic device may optionally perform an application discovery of CDM(s) attached to the electronic device in signal 1002 and establish a MediaKeySession in signal 1004.

In signal 1008, the application 214 may send a generateRequest( ) message to the Web Runtime Engine 212 thereby initializing a request for a DRM license. The Web Runtime Engine 212 may forward the generateRequest( ) message to the CDM 218 in signal 1010.

In response to the generateRequest( ) message, the CDM 218 may generate and transmit a license request message to the Web Runtime Engine 212 in signal 1012. The Web Runtime Engine 212 may generate and transmit a MediaKeyMessageEvent message to the application 214 in response to receiving the generateRequest( ) message.

The application 214 may extract/encode information from the MediaKeyMessageEvent message 1014 to determining a license URL in operation 1016. In some embodiments, the application 214 may figure out which license server corresponds to the content based on the extracted license URL. The application 214 may then generate and send a License_Message(licenseURL message) to the middleware 210 in signal 1018.

The middleware 210 may additionally verify whether or not the License_Message is valid. For example, when the CDM 218 and the middleware 210 are manufactured in a single device, there is little risk that the CDM 218 may be compromised because the CDM 218 is within the trusted execution environment of the electronic device. However, when the CDM 218 and the middleware 210 are coupled after manufacturing the CDM 218 is more susceptible to being compromised. Thus, the middleware 210 may perform additional operations to confirm that the License_Message was constructed using secure identifiers and/or information. Specifically, the middleware 210 may confirm that a license URL included in the License_Message is valid.

In signal 1020, the middleware 210 may receive a ROUTE license message. The ROUTE license message may be transmitted by a broadcast server (e.g., the broadcast server 204) and may include DRM license-related objects and messages such as the DRM license-related objects and messages included in signal 808.

In operation 1022, the middleware 210 may match a message hash and construct a response. For example, the middleware 210 may compare a hash associated with the License_Message received in signal 1018 with a hash of the ROUTE license message received in 1020 to identify a DRM license that may be used to decrypt the encrypted content. When the middleware 210 finds a DRM license that matches the information included in the License_Message, the middleware 210 may generate a notify licenseServerMsg where the payload of the notify licenseServerMsg includes the selected encrypted DRM license.

In signal 1024, the middleware 210 sends the notify licenseServerMsg to the application 214 where the application 214 converts the response into an ArrayBuffer in operation 1026. For example, the application 214 may convert notify licenseServerMsg from an ASCI-based message to a binary based message. The application may send the update(response) message in signal 1028 to the Web Runtime Engine 212 and the Web Runtime Engine 212 may forward information associated the license to the CDM 218 in signal 1030.

In various embodiments, the information associated with the license included in signal 1030 may be the actual encrypted DRM license, and the CDM 218 may decrypt the license message transmitted in signal 1030 to directly obtain the DRM license and the decryption key from the license message.

Alternatively, the information associated with the license could be information in which the CDM 218 may use to locate and retrieve the encrypted DRM license from a memory. For example, the encrypted DRM license may be stored in an array buffer of the electronic device, and the license message transmitted in signal 1030 may include information associated with where and/or how the CDM 218 may retrieve the encrypted DRM license from the array buffer. The array buffer may be any memory element of the electronic device including a secure memory element included in the trusted execution environment of the electronic device. In addition, the information associated with where and/or how the CDM 218 may retrieve the encrypted DRM license may include a pointer or other object that provides the CDM 218 with a location of the memory in which the encrypted DRM license is stored. The CDM 218 may use the pointer to retrieve the encrypted DRM license from the memory, and in response to retrieving the encrypted DRM license from memory, the CDM 218 may decrypt the encrypted DRM license to obtain the DRM license and corresponding decryption key.

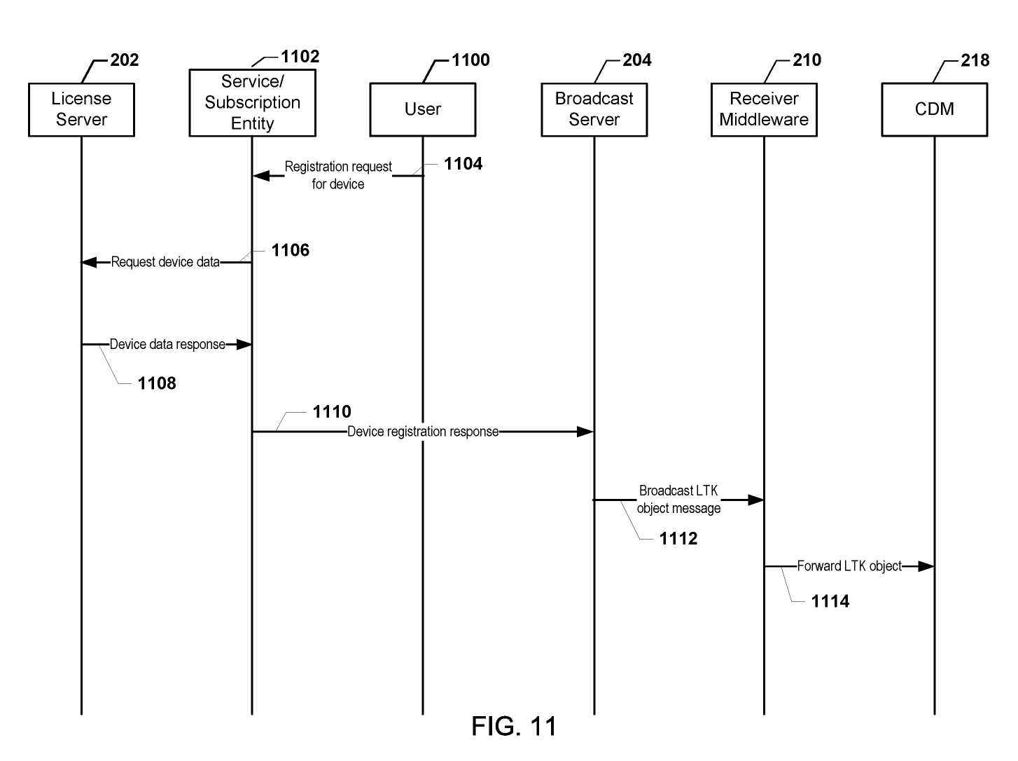

FIG. 11 illustrates a signal flow diagram for an embodiment method for registering an electronic device operating in a receive only mode, such as receive-only electronic device 208, to receive a broadcast subscription.

As illustrated in FIG. 11, a user 1100 may initiate a request for registering for a subscription of a broadcast service or program by sending the registration request for device in 1104 to a service/subscription entity 1102. In some embodiments, the service/subscription entity 1102 may include a communication interface and a server comprising a processor.

The user 1100 may use various devices and/or utilize various methods of communicating with the service/subscription entity 1102. For example, the user 1100 may send the registration request for device message in 1104 using the electronic device 208 when the electronic device 208 is operating in the unicast mode. Alternatively, the user 1100 may send the registration request for device message in 1100 using another electronic device capable of connecting with a network. The user 1100 may alternatively contact the service/subscription entity 1102 using a telephone or via short message service (SMS) in which the user 1100 communicates the information included in the registration request for device message 1104 over the telephone or SMS to a person within the service/subscription entity 1102.

The registration request for device message 1104 may include information that may allow the service/subscription entity 1102 to confirm or have confidence that the identity of the device associated with the registration request will be the same device receiving the requested broadcast service. For example, the registration request for device message 1104 may include a device unique identifier, such as a unique device number (UDN) or a MAC address. In addition, the registration request for device message 1104 may also include a hash of the public half of the public/private key associated with the digital certificate stored at the electronic device.

In some embodiments, the user 1100 may first tune the electronic device operating in the receive-only mode to a channel associated with the desired subscription. After being tuned to the specific channel, information associated with how to register for a subscription may be displayed on the electronic device. For example, the information associated with how to register for the subscription may include a phone number to contact (by phone or SMS message) the service/subscription entity 1102, a UDN, and a short UDN or other unique device identifier. The user 1100 may then use the phone number to contact the service/subscription entity 1102 by telephone call or text message and communicate the UDN displayed on the electronic device.

In signal 1106, the service/subscription entity 1102 may transmit the device data received in the registration request for device message to the license server 202. Based on the information included in the registration request for device message 1104, the license server 202 may confirm whether the electronic device has previously registered with the license server 202, whether the license server 202 has issued a digital certificate for the electronic device, and/or whether the electronic device is capable of receiving the broadcast subscription included in the registration request.

When the license server 202 determines that the electronic device is a valid device capable of receiving the requested broadcast service, the license server 202 may generate a long term key (LTK) corresponding to the requested broadcast service for the electronic device. For example, the license server 202 may generate a service encryption key (SEK) when the requested broadcast subscription is a broadcast service and a program encryption key (PEK) when the requested broadcast subscription is a broadcast program.

The LTK may be valid for a predetermined period of time that may correlate to a length of the requested broadcast subscription. The predetermined time period may be defined in terms of one or more of hours, days, weeks, months, or years. For example, if the duration of the broadcast subscription is scheduled to be a single program (e.g., sporting event, movie, etc.) the predetermined period of time may correlate to the intended time frame in which the program will be broadcast. If the duration of the broadcast subscription is scheduled for a service (e.g., TV show series, news time frame, sport team season, etc.), the predetermined time period may extend for the anticipated period in which each segment or session of the service will be received. For example, if the service is a TV show series, the predetermined time period may correlate to the number of weeks in which the TV show series will be broadcast. In addition, the LTK may be valid for a predetermined period less than the anticipated duration of the subscription. For example, the LTK may be valid for a month and a new LTK may be generated and distributed to the electronic device every month.

After generating the LTK, the license server 202 may encrypt the LTK to prevent unauthorized access to the LTK during distribution. For example, the license server 202 may encrypt the LTK using the public key associated with the digital certificate corresponding to the electronic device such that only the electronic device may access the LTK using the private key associated with the digital certificate.

In signal 1108, the license server 202 may transmit the encrypted LTK to the service/subscription entity 1102 in the device data response message, and the service/subscription entity 1102 may forward the encrypted LTK to the broadcast server in signal 1110. Alternatively, the license server 202 may forward the encrypted LTK directly to the broadcast server 204.

In signal 1112, the broadcast server 204 may transmit the LTK object message to the electronic device. The LTK object message may include the LTK, a signature of the license server generated by using the private key of the certificate of the license server, and the device unique identifier corresponding to the electronic device. The LTK object message may be encrypted using the public key of the digital certificate associated with the electronic device. In some embodiments, the device unique identifier may not be encrypted.

While the broadcast server 204 may transmit the LTK object message, the electronic device may acquire the LTK in various other ways including acquiring the LTK via manual provisioning. For example, after the license server 202 generates the LTK, the LTK may be installed on the electronic device via a truck roll in which a customer agent of the service/subscription entity 1102 may drive to the location of the electronic device and perform the registration (including installing the LTK) at the location of the electronic device. Alternatively, the user may bring the electronic device to a store or outlet associated with the service/subscription entity 1102 to perform the registration and install the LTK at the electronic device. In either of these methods, the process of manually provisioning the LTK may be a substitute for the above-described telephone call or SMS communications and the manually-installed LTK may be valid for a fixed time duration associated with the initial subscription. The manually provisioned LTK may be subsequently updated via broadcast LTK object message delivery as shown in signal 1112.

The middleware 210 may determine whether to receive the broadcast LTK object message 1112 based on information included in the broadcast LTK object message. For example, the middleware 210 may use the device unique identifier included in the LTK object message to determine whether to receive the broadcast LTK object message 1112. When the device unique identifier is unencrypted in the LTK object message, the middleware 210 may compare the device unique identifier with device identifier information unique to the device stored in the device.

In some embodiments, the middleware 210 may verify whether the LTK object message has been transmitted from an authentic source (e.g., an entity authenticated by the Certificate Authority) rather than an unauthorized source, such as a man-in-the-middle attacker that has forged the LTK object message (using a mobile transmitter) to create a denial-of-service attack or illegitimate content playout. In such embodiments, may verify that the LTK object message has been transmitted from an authentic source by determining whether the device unique identifier matches the device identifier information unique to the device stored in the device. In response to determining that the device unique identifier matches the device identifier information unique to the device stored in the device, the middleware 210 may decrypt at least a portion of the LTK object message using the public key associated with the digital certificate stored at the electronic device to obtain a digital certificate associated with the license server and a digital signature of the license server. The middleware 210 may decrypt the digital signature of the license server using the public key associated with the digital certificate of the license server to determine the authenticity of the digital signature. In some embodiments, the middleware of the electronic device may download the LTK object when the device unique ID matches the device ID of the electronic device and the verification of the license server signature produces the same LTK object as the LTK object included in the fourth broadcast message.

In response to downloading the LTK object message, the middleware 210 may forward the LTK object to the CDM 218 in signal 1114. The CDM 218 may decrypt the LTK object using the private key associated with the digital certificate stored in the device to obtain the LTK. The CDM 218 may store the decrypted LTK within a secure memory within the trusted execution environment.

In response to receiving the DRM license object selected by the middleware 210 (e.g., the DRM license object included in the License grant message in signal 822 and the Provide license messages 824 and 826), the CDM 218 may decrypt the DRM license object to obtain the DRM license and the content decryption key associated with the DRM license when the content decryption key remains encrypted. The CDM 218 may use the decrypted LTK to decrypt the encrypted content decryption key, and the CDM 218 may use the decrypted content decryption key (decrypted using the LTK) to decrypt the encrypted content included in the broadcast encrypted media.

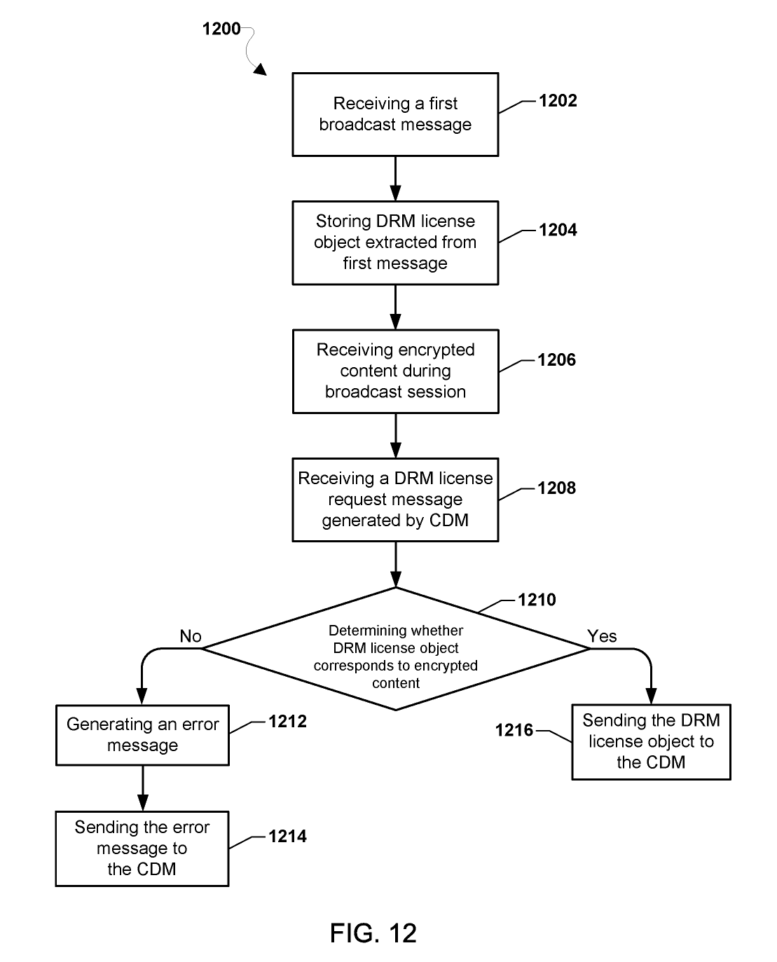

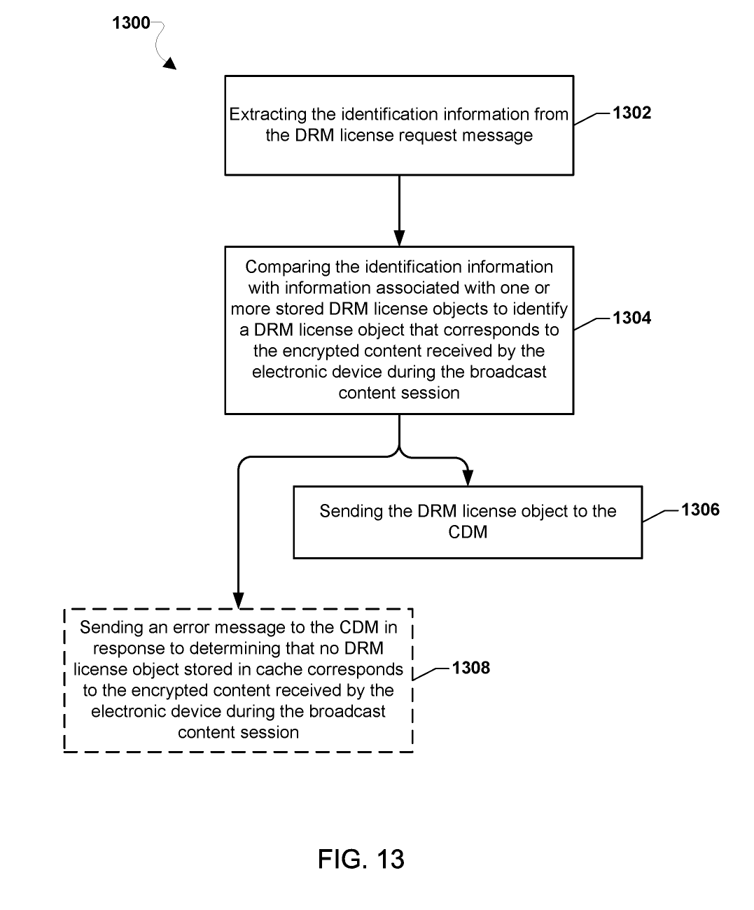

FIGS. 12-13 illustrate embodiment methods for facilitating DRM in an electronic device. FIG. 12 is a process flow diagram of an embodiment method 1200 for facilitating DRM in an electronic device. FIG. 13 is a process flow diagram of an embodiment method 1300 for determining whether a DRM license object corresponds to encrypted content in determination block 1210 of the method 1200. With reference to FIGS. 1-13, the methods 1200 and 1300 may be implemented by one or more processors of an electronic device. For example, the methods 1200 and 1300 may be implemented by processor 501 and/or processor 620. In addition, the methods 1200 and 1300 may be implemented by television 114, personal electronic device 116, electronic device 208, personal device 500, and/or electronic device 600.

In block 1202, the processor may receive a first broadcast message via wireless communication receiver of the electronic device. The first broadcast message may be a DRM license-related message generated by a broadcast server (e.g., broadcast server 104, 204, and/or 700). The DRM license-related message may be any of the previously discussed messages that includes one or more DRM license related information. In some embodiments, the DRM license-related message may include a DRM license object that is used to decrypt encrypted content, such as an encryption key, a digital certificate, etc. The DRM license-related message may or may not be encrypted, or a portion of the DRM license-related message may be encrypted while another portion of the DRM license-related message is not encrypted. In some embodiments, the DRM license object may include a DRM license and/or a content decryption key associated with the DRM license. The DRM license and/or the content decryption key may or may not be encrypted.

In block 1204, the processor may store the DRM license object extracted from the DRM license-related message in a cache of the electronic device. In some embodiments, the processor may execute middleware to extract the DRM license object and forward the extracted DRM license object to be stored to the cache. The DRM license object may additionally or alternatively be stored in another memory element of the electronic device.

In block 1206, the processor may receive encrypted content during a broadcast content session. The broadcast content session may be of any duration that the electronic device receives content to be displayed on a display of the electronic device. The content may be broadcast using real-time or non-real-time transmission techniques. In some embodiments, the content transmitted during a broadcast content session may include encrypted and/or unencrypted content. The electronic device may receive any number of broadcast content sessions. A single broadcast content session may include content associated with one content subject (e.g., a movie, a sporting event, etc.) or a plurality of different content subjects. Information associated with one content subject may be included in a plurality of broadcast content sessions. In other embodiments, the content received by the processor may be transmitted using unicast transmission techniques rather than broadcast techniques. While the encrypted content is illustrated in FIG. 12 as being received after the first broadcast message, the content received in block 1206 may be received before the first broadcast message.

In block 1208, the processor may receive a DRM license request message generated by the CDM. The DRM license request message generated by the CDM may include identifier information associated with encrypted content received during a broadcast content session. The identifier information may be any information used to identify the content, system, and/or devices associated with the content. For example, the identifier information may include information associated with one or more of a type of content, a communication protocol or format used to transmit the content, identification of a content server, a broadcast server, and/or a license server, etc.

In some embodiments, the CDM may generate the DRM license request message in response to receiving encrypted content such that information within the generated message is indicative of a request for a DRM license that is configured to allow the CDM to decrypt the encrypted content to be displayed using a display of the electronic device. In some embodiments, the DRM license request message generated by the CDM may include a URL that identifies a license server that issued any DRM license that is associated with the encrypted content. However, any other communication protocol and/or message format may be implemented.

In determination block 1210, the processor may determine whether the DRM license object stored in the cache corresponds to the encrypted content received during the broadcast session based on the identification information included in the DRM license request message. When a DRM license object is identified as corresponding to the encrypted content received during the broadcast session, the DRM license object may be used to decrypt at least a portion of encrypted content received during a broadcast content session.

In response to determining that no DRM license object stored in the cache corresponds to the encrypted content received during the broadcast session (i.e., determination block 1210=“No”), the processor may generate an error message in block 1212 and send the generated error message to the CDM in block 1214 to indicate that a DRM license corresponding to the encrypted content is not available. In embodiments in which the protocol between the processor and the cache uses the http protocol, the error message may be a 404 error message. In some embodiments, the processor may generate and send the error message to the CDM in a single operation (e.g., in block 1308 in FIG. 13).

In response to determining that the DRM license object received in the first broadcast message corresponds to the encrypted content received during the broadcast session (i.e., determination block 1210=“Yes”), the processor may send the DRM license object to the CDM in block 1216 so that the CDM may decrypt at least a portion of the encrypted content using the DRM license object. In some embodiments, the processor may obtain the DRM license object from the cache and send the DRM license object to the CDM. Alternatively, the processor may instruct the cache to send the DRM license object to the CDM without any further interaction with the processor.

The electronic device may be capable of only operating in a receive-only mode or the electronic device may be capable of selectively operating between a receiving mode and a transmitting mode. In some embodiments, the electronic device may be capable of simultaneously transmitting and receiving information.

In embodiments in which the electronic device is capable of operating in both a receiving mode and a transmitting mode, the processor may receive the first broadcast message described in block 1202 when the electronic device is operating in a receive-only mode. Additionally or alternatively, the processor may further the encrypted content received during the broadcast content session when the electronic device is operating in the receive-only mode.

In some embodiments, the processor may employ or be configured with middleware and/or one or more applications executed to display decrypted content on a display of the electronic device to perform one or more of the operations of the method 1200 illustrated in FIG. 12. For example, the processor may execute middleware to perform the operations of blocks 1202, 1204, 1208, 1210, 1212, and/or 1214. The one or more applications may be implemented to perform the operations of blocks 1202, 1206, 1208, 1210, 1212, 1214, and/or 1216.

The processor may employ various techniques to perform the operation of determining whether one or more DRM license objects stored in the cache corresponds to the encrypted content received during the broadcast session (e.g., block 1210) including, for example, the method 1300 illustrated in FIG. 13.

In block 1302, the processor may extract the identification information from the DRM license request message generated by the CDM.

In block 1304, the processor may compare the extracted identification information with information associated with one or more stored DRM license objects to identify a DRM license object stored in the cache that corresponds to the encrypted content received by the electronic device during the broadcast content session.

In some embodiments, one or more DRM license objects stored in the cache may be indexed, mapped, or otherwise categorized and/or identified by the processor in various ways. The identification information included in the DRM license request message generated by the CDM may be directly compared to indexing, mapping, categorization, and/or identification information associated with each DRM license object stored in the cache. For example, the processor may generate the indexing, mapping, categorization, and/or identification information associated with each DRM license object at the time the DRM license object was stored, moved, or modified in the cache. In some embodiments, the identification information may be used in a process for identifying a DRM license object by directly compared to the indexing, mapping, categorization, and/or identification information generated by the processor when the DRM license object was stored in the cache. For example, if the result of comparing the identification information included in the DRM license request message to the indexing, mapping, categorization, and/or identification information associated with each stored DRM license object results in a match, the stored DRM license object that corresponds to the indexing, mapping, categorization, and/or identification information associated with each stored DRM license object may be identified as corresponding to the encrypted content.

In block 1306, the processor may obtain the DRM license object from the cache and/or send the DRM license object to the CDM. In some embodiments, the processor may employ middleware that communicates with the cache and sends the identified DRM license object to the CDM via one or more applications executed to display decrypted content on a display of the electronic device.

In optional block 1308, the processor may send an error message to the CDM in response to determining that no DRM license object stored in the cache of the electronic device corresponds to the encrypted content received by the electronic device during the broadcast content session.

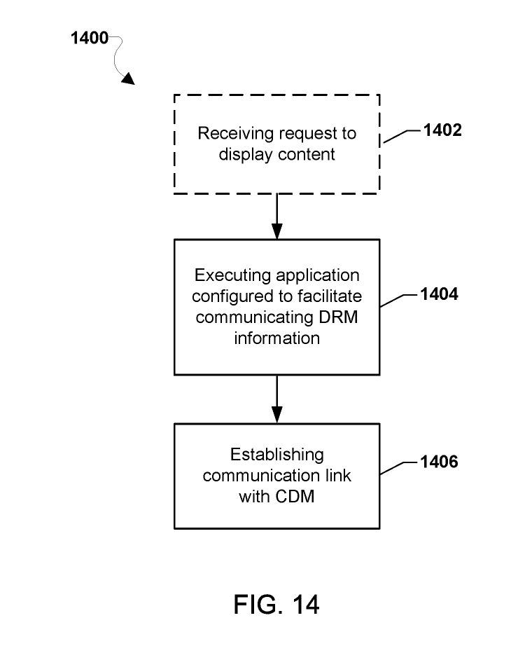

FIG. 14 illustrates an embodiment method for facilitating DRM in an electronic device using an application. With reference to FIGS. 1-14, the method 1400 may be implemented by one or more processors (e.g., processor 501 and/or processor 620) of an electronic device (e.g., television 114, personal electronic device 116, electronic device 208, personal device 500, and/or electronic device 600).

In optional block 1402, the processor may receive a request to display content. In some embodiments, the request to display the content may be an input provided by a user of the electronic device via a touch sensitive display or other input element of the electronic device (i.e., button, key, microphone, etc.) to launch an application configured to display content on a display of the electronic device. In other embodiments, the request to display the content may be a message (or information included in a message) received from another device. For example, the first broadcast message or the encrypted content received during the broadcast content session may serve as a trigger or include information that triggers instructions to execute the application.

In block 1404, the processor may execute an application configured to facilitate communicating DRM information within the electronic device. The application configured to facilitate communicating DRM information within the electronic device may only perform operations associated with facilitating DRM information communication or the application may perform additional operations related to displaying decrypted content on a display of the electronic device.

In block 1406, the processor may establish a communication link with the CDM using the application. In some embodiments, the communication protocol used between the processor and the CDM may be a WebSocket protocol or a HTTP protocol. The communication protocol used for communication between the processor and the CDM may be the same as or different from the communication protocol used for communication between the processor and the cache or the cache and the CDM.

In an embodiment, the processor may further execute middleware that communicates with the CDM using the WebSocket protocol via the application. For example, the CDM may send the DRM license request message to the middleware using the WebSocket protocol via the application. The middleware may use information in the DRM license request message to obtain a corresponding DRM license object from the cache and send DRM license object to the CDM. Alternatively, the middleware may instruct the cache to send a DRM license object to the CDM, and in response, the cache may provide the DRM license object to the CDM directly or via the application.

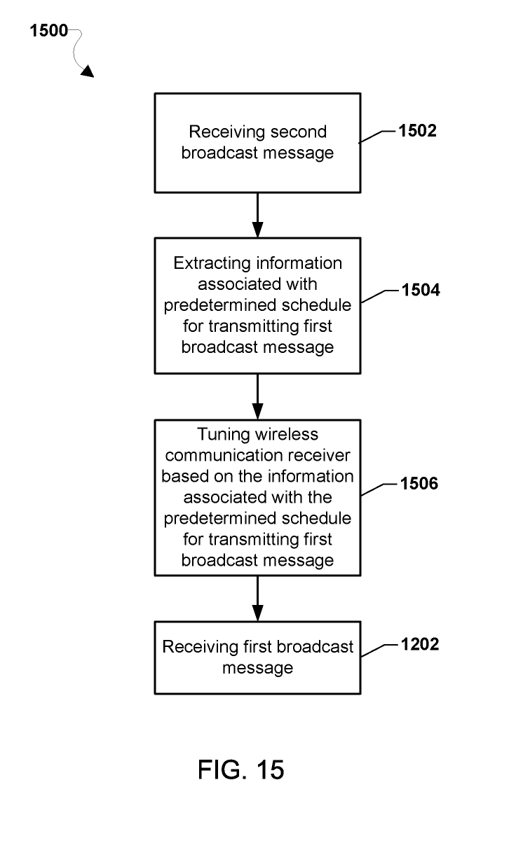

FIG. 15 illustrates an embodiment method for tuning a wireless receiver to receive broadcast messages. With reference to FIGS. 1-15, the method 1500 may be implemented by one or more processors (e.g., processor 501 and/or processor 620) of an electronic device (e.g., television 114, personal electronic device 116, electronic device 208, personal device 500, and/or electronic device 600).

In block 1502, the processor may receive a second broadcast message via a wireless communication receiver of the electronic device that includes information associated with a predetermined schedule for transmitting the first broadcast message. The second broadcast message may be configured to provide information from which the electronic device may determine when any message may be transmitted by the broadcast server (e.g., first broadcast message, broadcast content sessions, etc.), how often a message will be transmitted by the broadcast server, a frequency and/or channel in which the broadcast server will transmit the message, etc. For example, the second broadcast message may include scheduling information associated with a DRM license-related message (e.g., first broadcast message). In some embodiments, the second broadcast message may further include service level signaling. The service level signaling of the second broadcast message may include a DWD fragment that includes information associated with a predetermined schedule for transmitting broadcast messages. Each instance of a DWD fragment is assumed to be unambiguously identifiable in its association with the one or more broadcast content services to which the DRM license-related message (the first broadcast message) apply, for enabling consumption of the media content delivered by the one or more broadcast content services.

In block 1504, the processor may extract the information associated with the predetermined schedule for transmitting the first broadcast message from the second broadcast message to determined when the first broadcast message will be transmitted by the broadcast server and on which frequency and/or channel in which the first broadcast message will be transmitted.

In block 1506, the processor may tune the wireless communication receiver to the frequency and/or channel in which the first broadcast message will be transmitted at a time using the information extracted from the second broadcast message. After the wireless communication receiver is tuned to receive the first broadcast message, the electronic device may receive the first broadcast message in block 1202 of the method 1200 as described above.

In some embodiments, the different messages broadcast by the broadcast server may be transmitted on different frequencies and/or different channels. The electronic device may selectively tune to the different frequencies and/or channels based on the next broadcast message that the electronic device anticipates to receive.

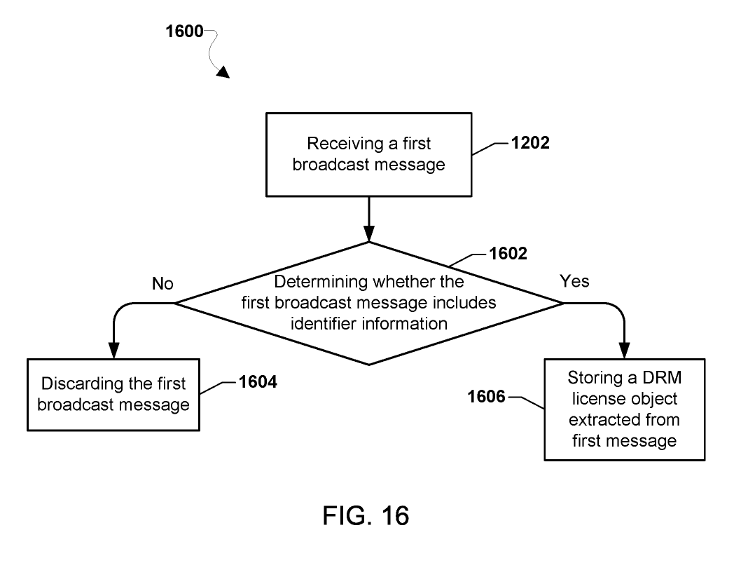

FIG. 16 illustrates an embodiment method for filtering DRM license-related messages. With reference to FIGS. 1-16, the method 1600 may be implemented by one or more processors (e.g., processor 501 and/or processor 620) of an electronic device (e.g., television 114, personal electronic device 116, electronic device 208, personal device 500, and/or electronic device 600).

In block 1202, the processor may receive the first broadcast message. In determination block 1602, the processor may determine whether the first broadcast message includes identifier information associated with the electronic device. In order to determine whether the electronic device should download and save a DRM license object included in the first broadcast message, the processor may compare the identifier information included in the first broadcast message with information stored at the electronic device. The identifier information may include one or more of a digital signature, a license server parameter, a broadcast server parameter, a content provider parameter, a content parameter, a channel parameter, a program parameter, a content time parameter, an overall time parameter, a type of content parameter, a device group parameter, and a unique device parameter (e.g., a unique device number (UDN)). In some embodiments, the identifier information of the first broadcast message may include a URL which may include an identity of a license server.

In response to determining that the first broadcast message does not include identifier information associated with the electronic device (i.e., determination block 1602=“No”), the processor may discard the first broadcast message in block 1604. For example, by discarding the first broadcast message, the processor refrains from performing any additional processing on the first broadcast message. Thus, the processor may avoid performing operations necessary to extract a DRM license object from the first broadcast message nor storing the DRM license object in the cache.

In response to determining that the first broadcast message includes identifier information associated with the electronic device (i.e., determination block 1602=“Yes”), the processor may extract the DRM license object from the first message and store the DRM license object in the cache in block 1606.

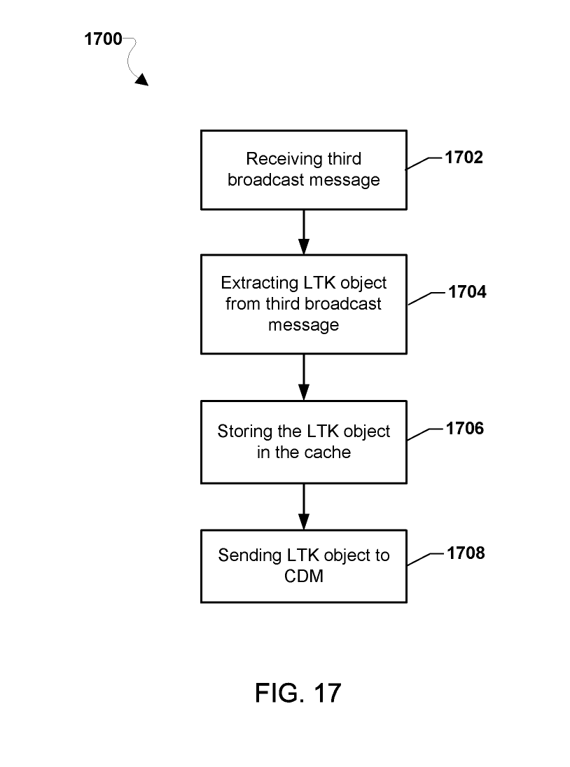

FIG. 17 illustrates another embodiment method for facilitating DRM in an electronic device. With reference to FIGS. 1-17, the method 1700 may be implemented by one or more processors (e.g., processor 501 and/or processor 620) of an electronic device (e.g., television 114, personal electronic device 116, electronic device 208, personal device 500, and/or electronic device 600).

In block 1702, the processor may receive a third broadcast message via the wireless communication receiver. The third broadcast message may include information associated with a broadcast service subscription that the electronic device is authorized to receive. In some embodiments the third broadcast message may include a long term key (LTK) object.

In block 1704, the processor may extract the LTK object from the third broadcast message. In block 1706, the processor may store the extracted LTK object in the cache of the electronic device.

In some embodiments, the LTK object may be encrypted such that in addition to extracting the LTK object from the third broad cast message, the processor may further decrypt the LTK object before storing the LTK object in the cache.

In block 1708, the processor may send the LTK object stored in the cache to the CDM. In some embodiments, the CDM may use the LTK object to decrypt the DRM object included in the first broadcast message.

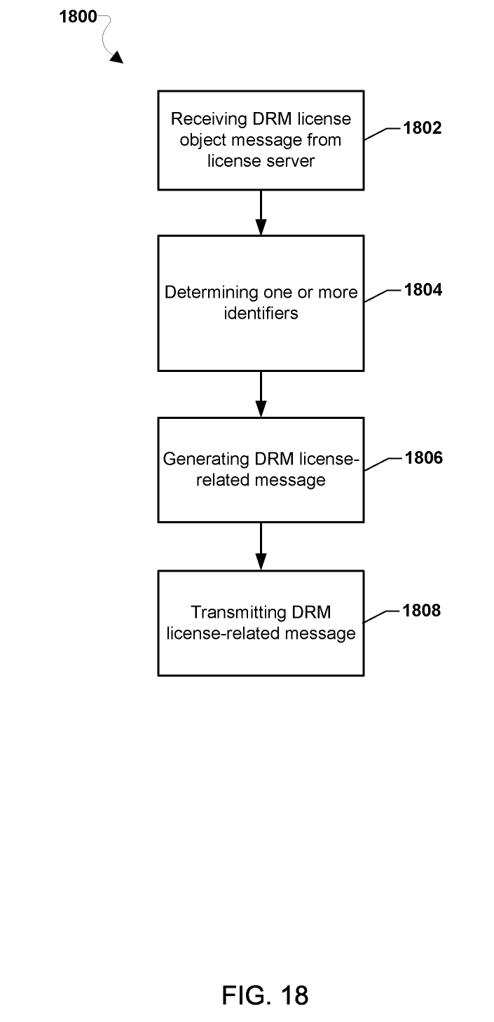

FIG. 18 illustrates an embodiment method for broadcasting DRM information. With reference to FIGS. 1-18, the method 1800 may be implemented by one or more processors (e.g., processor 701) of a broadcast server (e.g., broadcast server 104, 204, and/or 700).

A license server may identify a DRM license object that corresponds to encrypted content transmitted during a broadcast content session. The DRM license object message may include information that allows each wireless electronic device capable of operating in the receive-only mode and authorized to receive the encrypted content transmitted during the broadcast content session to display content on a display.

The license server may generate a DRM license object message including the identified DRM license object. In some embodiments, the license server may include identifier information associated with the DRM license object. The license server transmits the DRM license object message to a broadcast server.

In block 1802, the processor of the broadcast server may receive the DRM license object message from the license server.

In block 1804, the processor may determine one or more identifiers associated with the DRM license object message. The one or more identifiers may be one or more of a DRM system device identifier, a DRM system device group identifier, or a key identifier. The processor may determine the identifier from information included in the DRM license object message itself or from context information or metadata information associated with the DRM license object message.

In block 1806, the processor may generate the DRM license-related message. The DRM license-related message generated by the processor may include the DRM license object and at least one of the determined identifiers. In some embodiments, the determined identifiers included in the DRM license-related message may allow each wireless electronic device that receives the DRM license-related message to determine whether the DRM license-related message is intended for the particular wireless electronic device.

In block 1808, the processor may take actions to broadcast the DRM license-related message, such as by sending the DRM license-related message via a communication interface to a broadcast system or a wireless communication network for broadcast in a format that may be received by the one or more wireless electronic devices capable of operating in the receive-only mode.

In some embodiments, the processor may encrypt at least a portion of the DRM license-related message prior to broadcasting the DRIVI license-related message. In some embodiments, the license server or the broadcast server may identify wireless electronic devices that are authorized to receive the encrypted content.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module and/or processor-executable instructions, which may reside on a non-transitory computer-readable or non-transitory processor-readable storage medium. Non-transitory server-readable, computer-readable or processor-readable storage media may be any storage media that may be accessed by a computer or a processor. By way of example but not limitation, such non-transitory server-readable, computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory server-readable, computer-readable and processor-readable media. Additionally, the operations of a method or algorithm may reside as one or any combination or set of codes and/or instructions on a non-transitory server-readable, processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of facilitating digital rights management (DRM) in an electronic device, the method comprising:
receiving, by a processor of the electronic device via a wireless communication receiver of the electronic device, a first broadcast message, wherein the first broadcast message is a digital rights management (DRM) license-related message generated by a broadcast server;
storing, by the processor, a DRM license object extracted from the DRM license-related message in a cache of the electronic device;
receiving, by the processor, a DRM license request message generated by a content decryption module (CDM) executing on the electronic device, wherein the DRM license request message includes identifier information associated with encrypted content received by the electronic device during a broadcast content session;
determining, by the processor, whether the DRM license object stored in the cache of the electronic device is associated with the encrypted content received by the electronic device during the broadcast content session based on the identification information included in the DRM license request message received from the CDM of the electronic device; and
sending, by the processor, the DRM license object stored in the cache of the electronic device to the CDM executing on the electronic device in response to determining that the DRM license object stored in the cache of the electronic device is associated with the encrypted content received by the electronic device during the broadcast content session.

2. The method of claim 1, wherein determining whether the DRM license object stored in the cache of the electronic device is associated with the encrypted content received by the electronic device during the broadcast content session based on the identification information included in the DRM license request message received from the CDM executing on the electronic device comprises:
extracting the identification information from the DRM license request message received from the CDM executing on the electronic device;
comparing the identification information extracted from the DRM license request message with information associated with one or more DRM license objects stored in the cache to identify a DRM license object stored in the cache that is associated with the encrypted content received by the electronic device during the broadcast content session; and
sending the DRM license object to the CDM executing on the electronic device.

3. The method of claim 2, further comprising:
sending an error message to the CDM executing on the electronic device in response to determining that no DRM license object is stored in the cache of the electronic device is associated with the encrypted content received by the electronic device during the broadcast content session.

4. The method of claim 1, further comprising determining, by the processor, whether the first broadcast message includes an identifier associated with the electronic device,
wherein storing the DRM license object extracted from the DRM license-related message in the cache of the electronic device comprises storing the DRM license object extracted from the DRM license-related message in the cache of the electronic device in response to determining that the first broadcast message includes the identifier associated with the electronic device.

5. The method of claim 1, wherein the identifier information of the DRM license request message comprises a license server identifier corresponding to a DRM license associated with the encrypted content included in the broadcast content session.

6. The method of claim 1, wherein the DRM license request message includes a uniform resource identifier (URI).

7. The method of claim 1, further comprising:
receiving, by the processor via the wireless communication receiver, a second broadcast message, wherein the second broadcast message is a DRM license-related message including a long term key (LTK) object associated with a broadcast service subscription that the electronic device is authorized to receive, and wherein the second broadcast message is generated by the broadcast server;
storing, by the processor, the LTK object included in the second broadcast message to the cache of the electronic device in response to determining that the second broadcast message includes an identifier of a DRM system by which the broadcast service subscription is protected; and
sending, by the processor, the LTK object stored in the cache of the electronic device to the CDM executing on the electronic device, wherein the LTK object is associated with the identifier of the DRM system included in the second broadcast message.

8. The method of claim 7, further comprising receiving, by the processor via the wireless communication receiver, a third broadcast message different from the first broadcast message or the second broadcast message, and different from the encrypted content received during the broadcast content session, wherein:
the first broadcast message or the second broadcast message is transmitted from the broadcast server according to a predetermined schedule;
the third broadcast message includes service level signaling;
the service level signaling of the third broadcast message includes a distribution window description (DWD) fragment; and
the DWD fragment includes information associated with the predetermined schedule in which the first broadcast message or the second broadcast message is transmitted from the broadcast server.

9. The method of claim 1, wherein the electronic device is only capable of operating in a receive-only mode.

10. The method of claim 7, wherein the electronic device is configured to operate in a receive-only mode and a transmit mode.

11. The method of claim 10, wherein receiving the first broadcast message or the second broadcast message comprises receiving the first broadcast message or the second broadcast message when the electronic device is operating in the receive-only mode.

12. The method of claim 10, further comprising:
receiving, by the processor via the wireless communication receiver, the encrypted content during the broadcast content session when the electronic device is operating in the receive-only mode.

13. The method of claim 1, further comprising:
executing, by the processor, middleware configured to communicate with the CDM; and
executing, by the processor, an application configured to facilitate communicating DRM information between the middleware and the CDM.

14. The method of claim 13, wherein the application communicates information between the middleware and the CDM using a WebSocket protocol.

15. An electronic device configured to receive encrypted content, comprising:
a display configured to display content;
a wireless communication receiver configured to receive wireless signals from a communication network;
a content decryption module (CDM) configured to decrypt encrypted content;
a memory including a cache; and
a processor coupled to the display, the wireless communication receiver, the CDM, and the memory, and configured with processor-executable instructions to perform operations comprising:
receiving, via the wireless communication receiver, a first broadcast message, wherein the first broadcast message is a digital rights management (DRM) license-related message generated by a broadcast server;
storing a DRM license object extracted from the DRM license-related message of the first broadcast message in a cache;
receiving a DRM license request message generated by the CDM, wherein the DRM license request message includes identifier information associated with encrypted content received during a broadcast content session;
determining whether the DRM license object stored in the cache is associated with the encrypted content received during the broadcast content session based on the identification information included in the DRM license request message received from the CDM;
sending the DRM license object stored in the cache to the CDM in response to determining that the DRM license object stored in the cache is associated with the encrypted content received during the broadcast content session;
receiving, via the wireless communication receiver, a second broadcast message, wherein the second broadcast message is a DRM license-related message generated by the broadcast server, and wherein the second broadcast message includes a long term key (LTK) object associated with a broadcast service subscription that the electronic device is authorized to receive;
storing, by the processor, the LTK object included in the second broadcast message to the cache of the electronic device in response to determining that the second broadcast message includes an identifier of a DRM system by which the broadcast service subscription is protected; and
sending, by the processor, the LTK object stored in the cache of the electronic device to the CDM executing on the electronic device, wherein the LTK object is associated with the identifier of the DRM system included in the second broadcast message.

16. The electronic device of claim 15, wherein the processor is configured with processor-executable instructions to perform operations such that determining whether the DRM license object stored in the cache is associated with the encrypted content received during the broadcast content session based on the identification information included in the DRM license request message received from the CDM comprises:
extracting the identification information from the DRM license request message received from the CDM;
comparing the identification information extracted from the DRM license request message with information associated with one or more DRM license objects stored in the cache to identify a DRM license object stored in the cache that is associated with the encrypted content received by the electronic device during the broadcast content session; and
sending the identified DRM license object to the CDM.

17. The electronic device of claim 16, wherein the processor is configured with processor-executable instructions to perform operations further comprising:
sending an error message to the CDM in response to determining that no DRM license object stored in the cache is associated with the encrypted content received by the electronic device during the broadcast content session.

18. The electronic device of claim 15,
wherein the processor is configured with processor-executable instructions to perform operations further comprising:
receiving, via the wireless communication receiver, a third broadcast message different from the first broadcast message or the second broadcast message, and different from the encrypted content received during the broadcast content session;
wherein the first broadcast message or the second broadcast message is transmitted according to a predetermined schedule;
wherein the third broadcast message includes service level signaling;
wherein the service level signaling of the third broadcast message includes a distribution window description (DWD) fragment;
wherein the DWD fragment includes information associated with the predetermined schedule in which the first broadcast message or the second broadcast message is transmitted from the broadcast server; and
wherein the predetermined schedule indicates one or more absolute time intervals during which the first broadcast message or the second broadcast message will be transmitted.

19. The electronic device of claim 15,
wherein the processor is configured with processor-executable instructions to perform operations further comprising:
determining whether the first broadcast message includes an identifier associated with the electronic device; and
wherein the processor is configured with processor-executable instructions to perform operations such that storing the DRM license object extracted from the DRM license-related message in the cache comprises storing the DRM license object extracted from the DRM license-related message in the cache in response to determining that the first broadcast message includes the identifier associated with the electronic device.

20. The electronic device of claim 15, wherein the identifier information of the DRM license request message comprises a license server identifier corresponding to a DRM license associated with the encrypted content included in the broadcast content session.

21. The electronic device of claim 15, wherein the DRM license request message includes a uniform resource identifier (URI).

22. The electronic device of claim 15, wherein the processor is configured with processor-executable instructions that include middleware configured to cause the processor to perform operations of receiving the DRM license request message generated by the CDM and determining that the DRM license object stored in the cache of the memory is associated with the encrypted content received during the broadcast content session based on the identification information included in the DRM license request message received from the CDM.

23. The electronic device of claim 15, wherein the electronic device is only capable of operating in a receive only mode.

24. The electronic device of claim 15, further comprising a transmitter configured to transmit information,
wherein the processor is configured with processor-executable instructions to perform operations further comprising:
transmitting, via the transmitter, information when the electronic device is operating in a unicast mode; and
preventing transmission of information via the transmitter when the electronic device is operating in a receive-only mode.

25. The electronic device of claim 24, wherein the processor is configured with processor-executable instructions to perform operations such that receiving the first broadcast message or the second broadcast message comprises receiving the first broadcast message or the second broadcast message when the electronic device is operating in the receive-only mode.

26. The electronic device of claim 24, wherein the processor is configured with processor-executable instructions to perform operations further comprising:
receiving, via the wireless communication receiver, the encrypted content during the broadcast content session when the electronic device is operating in the receive-only mode.

27. The electronic device of claim 15, wherein the processor is configured with processor-executable instructions to perform operations further comprising:
executing middleware configured to communicate with the CDM; and
executing an application configured to facilitate communicating DRM information within the electronic device.

28. The electronic device of claim 27, wherein the application communicates information between the middleware and the CDM using a WebSocket protocol.

29. A method of broadcasting digital rights management (DRM) information, the method comprising:
receiving, at a processor of a broadcast server, a first DRM license object message including a first DRM license object and a second DRM license object message including a second DRM license object generated by a license server, wherein the first DRM license object and the second DRM license object are associated with one or more wireless electronic devices capable of operating in a receive-only mode;
determining, by the processor of the broadcast server, one or more identifiers based on the first DRM license object message and the second DRM license object message received from the license server, wherein the one or more identifiers include at least one of a DRM system device identifier, a DRM system device group identifier, or a key identifier;
generating, by the processor of the broadcast server, a first DRM license-related message including the first DRM license object and at least one of the determined identifiers and a second DRM license-related message including the second DRM license object and at least one of the determined identifiers; and
broadcasting, by the processor of the broadcast server via a wireless communication network, the first DRM license-related message and the second DRM license-related message.

30. A broadcast server configured to broadcast digital rights management (DRM) information, comprising:
a network interface configured to communicate with a wireless communication network;
a memory; and
a processor coupled to the network interface and the memory, and configured to with processor-executable instructions to perform operations comprising:
receiving a first DRM license object message including a first DRM license object and a second DRM license object message including a second DRM license object generated by a license server, wherein the first DRM license object and the second DRM license object are associated with one or more wireless electronic devices capable of operating in a receive-only mode;
determining one or more identifiers based on the first DRM license object message and the second DRM license object message received from the license server, wherein the one or more identifiers include at least one of a DRM system device identifier, a DRM system device group identifier, or a key identifier;
generating a first DRM license-related message including the first DRM license object and at least one of the determined identifiers and a second DRM license-related message including the second DRM license object and at least one of the determined identifiers; and
broadcasting, via the wireless communication network, the first DRM license-related message and the second DRM license-related message to the one or more wireless electronic devices capable of operating in the receive-only mode.
